(19) United States
(12) Patent Application Publication
(10) Pub. No.: US 2026/0014476 A1
(43) Pub. Date: Jan. 15, 2026

(54) ONE OR MORE NON-TRANSITORY COMPUTER-READABLE MEDIA, INFORMATION PROCESSING SYSTEM, INFORMATION PROCESSING METHOD, AND INFORMATION PROCESSING APPARATUS

(71) Applicant: NINTENDO CO., LTD., Kyoto (JP)

(72) Inventors: Shintaro JIKUMARU, Kyoto (JP); Shoichi OBAYASHI, Kyoto (JP)

(21) Appl. No.: 19/060,001

(22) Filed: Feb. 21, 2025

(30) Foreign Application Priority Data
Jul. 10, 2024 (JP) 2024-110867
Jul. 10, 2024 (JP) 2024-110868

(51) Int. Cl. A63F 13/63; A63F 13/577; A63F 13/803

(52) U.S. Cl. CPC A63F 13/63; A63F 13/577; A63F 13/803

(57) ABSTRACT

In an example of a game system according to an exemplary embodiment, when a player character is caused to run on a field, the player character is caused to acquire an item in a first classification, the player object is changed to a playable character of a first type of the same type as and different in external appearance from the player character or to a playable character of a second type of a type different from the player character, the playable character is caused to run as the player character, and the playable character as the change destination is set to selectable on a selection screen.

### CROSS REFERENCE TO RELATED APPLICATION

This application claims priority to Japanese Patent Application No. 2024-110867 and Japanese Patent Application No. 2024-110868 filed on Jul. 10, 2024, the entire contents of which are incorporated herein by reference.

### FIELD

An exemplary embodiment relates to one or more non-transitory computer-readable media, an information processing system, an information processing method, and an information processing apparatus that enable the execution of a racing game.

### BACKGROUND AND SUMMARY

Conventionally, there is a game where a race is performed by selecting any of a plurality of characters and operating the selected character.

In the above conventional game, an object selected by a player is caused to run in accordance with an operation.

An exemplary embodiment discloses one or more non-transitory computer-readable media, an information processing system, an information processing method, and an information processing apparatus that are capable of changing a player object while the player object is running in a game where a selected player object is caused to run in accordance with an operation.

The exemplary embodiment employs the following configurations.

### First Configuration

Instructions according to a first configuration, when executed, cause one or more processors of an information processing apparatus to execute game processing including: in a first scene where a player is allowed to select a player object, allowing the player to select the player object to be used by the player from selectable playable objects among playable objects of a plurality of types based on an operation input. The game processing further includes, in a second scene where the player object is caused to run, causing the player object to run on a field based on an operation input, and based on acquisition of an item in a first classification on the field by the player object, changing the player object to a playable object of a first type of the same type as and different in external appearance from the player object or to a playable object of a second type of a type different from the player object, causing the playable object to run as the player object, and if the playable object as the change destination is not selectable in the first scene, setting the playable object to selectable.

Based on the above, while a player object is running, it is possible to change the appearance of the player object. It is possible to cause the player object to run while increasing selectable playable objects.

### Second Configuration

According to a second configuration, in the first configuration, the game processing may further include in the second scene, if the player object is changed to, between a playable object of the first type and a playable object of the second type, the playable object of the second type based on acquisition of an item in the first classification, after a lapse of a predetermined period, changing the playable object again to the player object before the change.

Based on the above, if the player object is changed to a playable object of a type different from the player object, after the lapse of a predetermined time, the playable object is changed back to the original player object, whereby it is possible to cause a player to experience a temporary change in the appearance.

### Third Configuration

According to a third configuration, in the second configuration, the playable objects may be characters. A playable object of the first type may be set with respect to each character of the player object and the same character as the character and may be any of a plurality of characters different in costume. A playable object of the second type may be an object of a character different from the character of the player object.

Based on the above, it is possible to change the player character to the same character different in costume or to a character different from the player character.

### Fourth Configuration

According to a fourth configuration, in the third configuration, a playable object of the second type may be a character for which the same character different in costume is not set.

Based on the above, it is possible to temporarily change the player character to any of a plurality of characters that are not different in costume, and cause the player to perform a game using various characters.

### Fifth Configuration

According to a fifth configuration, in the third or fourth configuration, the game processing may further include: in the first scene, allowing the player to select a vehicle object that the character is to be on based on an operation input; and in the second scene, causing the character to run in a state where the character is on the selected vehicle object.

Based on the above, it is possible to allow the player to select a vehicle object and cause a character to run on the selected vehicle object.

### Sixth Configuration

According to a sixth configuration, in any of the first to fifth configurations, the game processing may further include: in the second scene, in accordance with acquisition of an item in the first classification, bringing the player object into a state where a first effect relating to the item in the first classification is implementable; and in a state where the first effect is implementable, in accordance with an instruction to use the item in the first classification based on an operation input, changing the player object to a playable object relating to the first effect between the playable object of the first type and the playable object of the second type and producing an effect regarding running relating to the first effect.

Based on the above, it is possible to produce an effect regarding running while increasing selectable playable objects. Thus, it is possible to increase playable objects as a part of a game without disturbing the game.

### Seventh Configuration

According to a seventh configuration, in the sixth configuration, the effect regarding the running relating to the first effect may be an effect of accelerating the player object. The game processing may further include: in the second scene, in accordance with acquisition of an item in a second classification on the field by the player object, bringing the player object into a state where a second effect that is any of a plurality of effects relating to a type of the item in the second classification and including an effect of accelerating the playable object is implementable and that does not involve a change of the player object; and in the state where the second effect is implementable, in accordance with an instruction to use the item in the second classification based on an operation input, producing the second effect.

Based on the above, it is possible to acquire an item in a first classification instead of an item in a second classification while the player object is running, and accelerate the player object, and it is also possible to increase selectable playable objects. Thus, it is possible to naturally increase selectable playable objects during a racing game.

### Eighth Configuration

According to an eighth configuration, in any of the first to seventh configurations, the game processing may further include, in a third scene included in the second scene, setting a movement range along a predetermined path on the field, moving a plurality of objects including the player object within the movement range, and causing the plurality of objects to race each other.

Based on the above, even when a racing game where a plurality of objects including the player object are moved along a predetermined path is performed, it is possible to increase selectable playable objects without disturbing the race.

### Ninth Configuration

According to a ninth configuration, in the eighth configuration, the game processing may further include in a fourth scene included in the second scene, causing the player object to run on the field based on an operation input without setting the movement range along the path on the field.

Based on the above, also in a scene where the player object is caused to freely run on a field, it is possible to increase selectable playable objects.

### Tenth Configuration

According to a tenth configuration, at least any of a change of the player object to which of playable objects of the first type and a change of the player object to which of playable objects of the second type may be set in association with respect to each of types of items in the first classification with respect to each player object. The game processing may further include in the second scene, based on acquisition of an item in the first classification, changing the player object to a playable object of the first type or a playable object of the second type relating to the type of the acquired item in the first classification.

Based on the above, in accordance with the type of the player object and the type of an item in a first classification, a playable object as a change destination is set. Consequently, for example, in a case where a certain player object is selected, it is possible to change the player object in various ways by acquiring various items in the first classification. In a case where another player object is selected, it is possible to change the player object to a different playable object even if an item in the first classification of the same type is acquired.

### Eleventh Configuration

According to an eleventh configuration, in any of the first to tenth configurations, the game processing may further include, in the second scene, based on contact between the player object and any of item acquisition objects which are placed at a plurality of locations on the field such that at least one of types of items in the first classification is set with respect to each location, causing the player object to acquire an item in the first classification of the type set for the item acquisition object.

Based on the above, in accordance with the placement location of an item acquisition object on a field, the type of an item in the first classification is set. Thus, it is possible to provide a player with a motivation to cause the player object to run through various locations on the field to.

Another configuration may be an information processing system that executes the above game program, an information processing apparatus, or an information processing method.

According to the exemplary embodiment, while a player object is running, it is possible to change the appearance of the player object.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of a character selection screen;

FIG. 4 is an example non-limiting diagram showing an example of the entirety of a field F in a virtual space;

FIG. 5 is an example non-limiting diagram showing an example of a base area A1;

FIG. 6 is an example non-limiting diagram showing an example of a game image displayed during a first racing game or a second racing game and is an example non-limiting diagram showing an example of a game image displayed before a player character 50 acquires an item in a first classification;

FIG. 7 is an example non-limiting diagram showing an example of a game image displayed after FIG. 6 and is an example non-limiting diagram showing an example of a game image displayed after the player character 50 acquires the item in the first classification;

FIG. 8 is an example non-limiting diagram showing an example of a game image displayed after an instruction to use the item is given in FIG. 7;

FIG. 9 is an example non-limiting diagram showing an example of a game image displayed when a character selection screen is displayed after the player character changes to a player character 50b based on the fact that the player character acquires an item X1 during a racing game;

FIG. 10 is an example non-limiting diagram showing another example of a game image displayed after an instruction to use the item is given in FIG. 7;

FIG. 11 is an example non-limiting diagram showing an example of a game image displayed when the character selection screen is displayed after the player character changes to a player character 60 based on the fact that the player character acquires the item X1 during the racing game;

FIG. 12 is an example non-limiting diagram showing an example of the association between an item X and a character as a change destination of a character of a first type that has used the item X;

FIG. 13 is an example non-limiting diagram showing an example of the association between an item X and a character as a change destination of a character of a second type that has used the item X;

FIG. 14 is an example non-limiting diagram showing examples of second item acquisition objects 75 placed on the field;

FIG. 15 is an example non-limiting diagram showing an example of a game image displayed when the player character hits the second item acquisition objects 75 and acquires an item in a second classification;

FIG. 16 is an example non-limiting diagram showing an example of a map UI displayed in a case where a player performs a predetermined operation during the execution of the second racing game;

FIG. 17 is an example non-limiting diagram showing an example of an image displayed when a character 51 is selected in the map UI;

FIG. 18A is an example non-limiting diagram showing an example of a game image displayed when the second racing game is executed using a player character 50a immediately before the map UI is displayed;

FIG. 18B is an example non-limiting diagram showing an example of a game image displayed when the second racing game is resumed by changing the player character from the character 50a to a character 51a in the map UI;

FIG. 19 is an example non-limiting diagram showing examples of various pieces of data used in game processing by a game system 1;

FIG. 20 is an example non-limiting flow chart showing an example of a game setting process performed when an instruction to execute a game program is given;

FIG. 21 is an example non-limiting flow chart showing an example of first game processing;

FIG. 22 is an example non-limiting flow chart showing an example of a first item process in step S13;

FIG. 23 is an example non-limiting flow chart showing an example of a second item process in step S14;

FIG. 24 is an example non-limiting flow chart showing an example of second game processing; and

FIG. 25 is an example non-limiting flow chart showing an example of a map UI process in step S43.

### DETAILED DESCRIPTION OF NON-LIMITING EXAMPLE EMBODIMENTS

### (Game System Configuration)

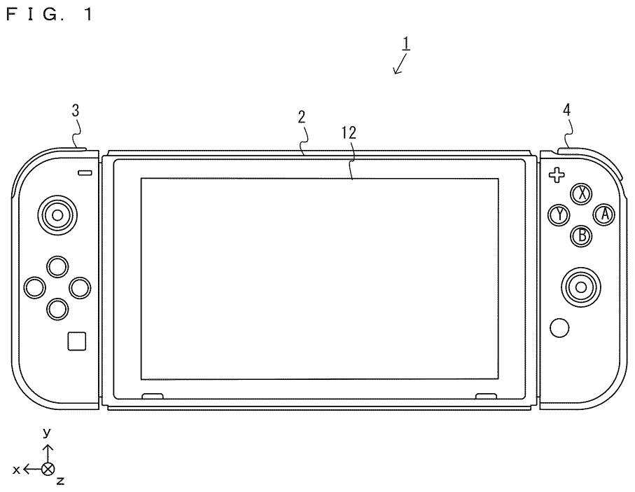

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of buttons (an A-button, a B-button, an X-button, a Y-button, an L-button, and an R-button) and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

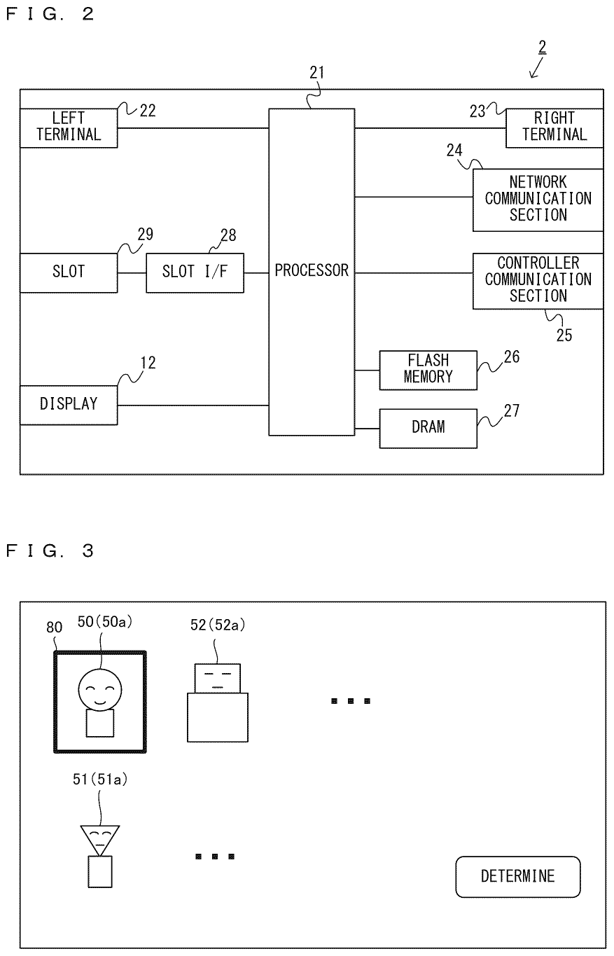

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### (Overview of Game)

Next, an overview of a game executed by the game system 1 is described. A game according to the exemplary embodiment is a racing game where a vehicle object with a character on board is caused to run on a field in a virtual space (a game space).

In the racing game according to the exemplary embodiment, characters of a plurality of types are prepared as a character to be operated by a player in the racing game. For example, the player selects a character to be operated by the player themselves from among a plurality of characters on a character selection screen at the start of the game. Here, a character operated by the player is referred to as a “player character”. A character that can be the player character is referred to as a “playable character”. In accordance with the character type, the characteristics of the character in the racing game are set. Specifically, characteristics that differ depending on the character type are set. However, a plurality of character types having equivalent characteristics may be included.

FIG. 3 is a diagram showing an example of a character selection screen. For example, before the racing game is started, a character selection screen shown in FIG. 3 is displayed. The player selects a player character to be operated by the player themselves from among a plurality of selectable playable characters on the character selection screen using a cursor 80 and determines the player character using a “determine” button in this state.

The character selection screen displays a plurality of playable characters selectable by the player at the current moment. Initially, on the character selection screen, not all the playable characters are set to selectable by the player, and only some of the playable characters are set to selectable. Although the details will be described below, the player acquires and uses a predetermined item (an item in a first classification described below) during the racing game, whereby a playable character that is not set to selectable on the character selection screen is set to selectable. In other words, the playable character is released.

For example, as playable characters, a character 50, a character 51, a character 52, and the like are prepared. In the exemplary embodiment, as the character 50, a plurality of characters that are the character 50 of the same type and only different in external appearance are prepared. For example, as the character 50, characters 50a, 50b, and 50c different in costume are prepared. Since the characters 50a to 50c are a character of the same type, the characteristics of the characters 50a to 50c are the same as each other, but the external appearances of the characters 50a to 50c are different from each other.

Specifically, the characters 50a, 50b, and 50c are different in worn costume (clothes, a hat, and the like). In the exemplary embodiment, 3D model data D50a indicating the character 50a, 3D model data D50b indicating the character 50b, and 3D model data D50c indicating the character 50c are stored in advance in a memory (the flash memory 26, the DRAM 27, or the predetermined type of storage medium attached to the slot 29). Among the characters 50a to 50c different in costume, only the character 50a is set to selectable at the current moment.

Similarly, as playable characters, a plurality of characters 51 (e.g., 51a to 51d) different in costume are prepared in advance. Among the characters 51a to 51d different in costume, only the character 51a is set to selectable at the current moment. Similarly, as playable characters, a plurality of characters 52 (e.g., 52a and 52b) different in costume are prepared in advance. Between the characters 52a and 52b different in costume, only the character 52a is set to selectable at the current moment.

The characters 50a, 51a, and 52a are characters initially set to selectable on the character selection screen.

Hereinafter, characters of the same type are represented by the same number, and the differences between the costumes are represented by alphabetical letters. For example, “character 50” indicates the character type, and “character 50b” indicates a character that is the character 50 wearing a particular costume. A character to whose number the alphabetical letter “a” is added is a character initially set to selectable on the character selection screen and is a character having the basic external appearance of the character. For example, the character 50a is a character initially set to selectable on the character selection screen and is a character having the basic external appearance of the character 50. At the start of the game, a character of which the character type itself is not released may be included. In this case, if a predetermined condition is satisfied, the character type is released, and a character of this type having the basic external appearance is released first. A character to be released first is equivalent to the above initial character. The same applies to the character 51a and the character 52a.

Here, a character having a plurality of costumes is referred to as “a character of a first type”. In the exemplary embodiment, as characters of the first type, characters of a plurality of types are also prepared in addition to the characters 50 to 52. The numbers of costumes prepared in advance differ depending on the characters. For example, the character 50 includes the three characters 50a to 50c different in costume, and the character 51 includes the four characters 51a to 51d different in costume.

“Different in costume” includes the state where at least a part of what is worn by a character (e.g., clothes, a hat, eyeglasses, sunglasses, an accessory, and the like) is different. For example, the character 50a and the character 50b may be different overall in what is worn by the character 50, or the character 50a and the character 50c may be different only in a part of what is worn by the character 50 (e.g., the type of a hat or the presence or absence of a hat). Alternatively, the costumes may be different only in color. The difference is not limited to the difference in what is worn, and for example, may be the difference in hairstyle.

In the exemplary embodiment, although not shown in FIG. 3, as a playable character, a character of a second type (e.g., a character 60 described below) different from the characters of the first type is prepared. A character of the second type is a character that does not have a plurality of costumes, and is a character for which only a single 3D model is prepared. In the exemplary embodiment, as characters of the second type, characters of a plurality of types are prepared. For example, as characters of the second type, a character 60 representing a dog, a character representing a cow, and the like are prepared.

The character selection screen may be displayed not only before the start of the racing game, but also during the racing game so that the player character may be able to be changed. For example, in accordance with a predetermined operation during a second racing game described below, the character selection screen is displayed, and the player may be allowed to change the player character on the character selection screen.

A vehicle object comes in a plurality of types different in external appearance, shape, size, power, and the like. For example, before the racing game is started, the player selects a vehicle object to be used by the player themselves on a vehicle object selection screen (not shown). The vehicle object may be an object that moves on the ground, such as a car, a motorcycle, or a bicycle. The vehicle object is not limited to an object that moves on the ground, and may be an object that moves on water or under water, such as a ship, a boat, or a submarine. The vehicle object may be an object that moves in the air, such as an airplane, a helicopter, or a glider, or may be an object that moves along the ground in the state where the object floats a predetermined distance from the ground. No matter what type the vehicle object is of, the vehicle object may be able to move not only on the ground but also on water, or may be able to move in the air by temporarily separating from the ground.

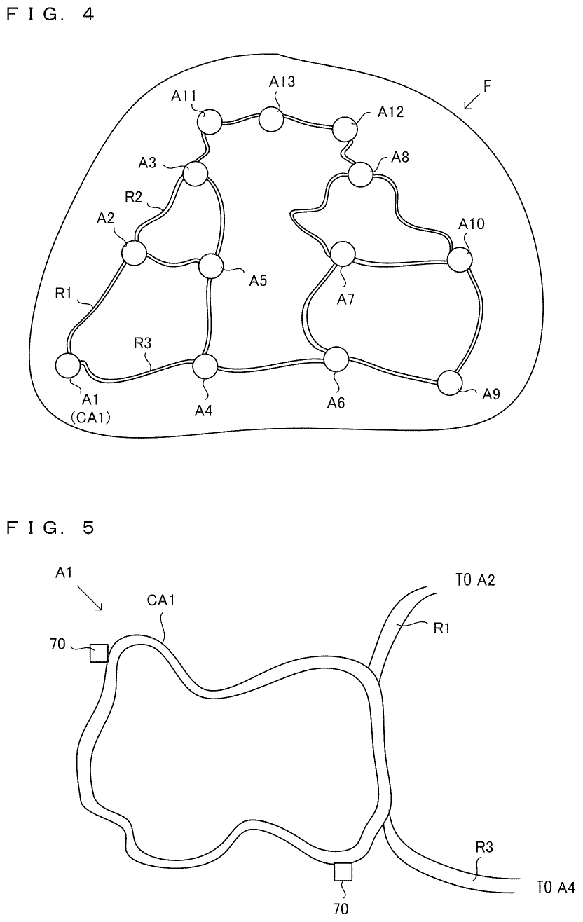

Next, a description is given of a field in the virtual space where the racing game according to the exemplary embodiment is performed. FIG. 4 is a diagram showing an example of the entirety of a field F in the virtual space.

The racing game according to the exemplary embodiment is performed on a broad field F set in the virtual space. As shown in FIG. 4, a plurality of base areas A (locations) are set on the field F in the virtual space. In FIG. 4, as the plurality of base areas A, base areas A1 to A13 are represented as circles. Each base area A includes an intra-base route CA where the player character can perform the racing game. For example, the base area A1 is an area indicating a single city. The base area A1 includes an intra-base route CA1 formed by a road where the vehicle object can be caused to run. For example, the base area A2 includes an intra-base route CA2 that is a racing circuit.

A plurality of base areas are linked together by an inter-base route R where the player character (the vehicle object) can be caused to run. For example, the base areas A1 and the base area A2 are linked together by an inter-base route R1. The base area A2 and the base area A3 are linked together by an inter-base route R2.

Hereinafter, an inter-base route R connecting base areas will occasionally be referred to simply as a “route R”. An intra-base route CA provided in a base area will occasionally be referred to simply as a “route CA”.

In the exemplary embodiment, the player can execute a first racing game where the vehicle object with the player character on board (hereinafter occasionally referred to simply as the “player character”) is caused to run along a route CA and/or a route R provided on the field F. The first racing game is a game where vehicle objects with a plurality of characters on board (hereinafter referred to simply as the “characters”) run a course where a starting point is set on any of a plurality of intra-base routes CA and/or inter-base routes R on the field and a goal point is set on an intra-base route CA and/or an inter-base route R that are the same as or different from the starting point. In the first racing game, the characters basically run along a course set on the field and compete on the rankings until the characters reach the goal point. For example, the first racing game where, on a course where a starting point and a goal point are set on the intra-base route CA1, a plurality of characters take multiple laps around the course is performed. There is also a case where the first racing game where a course including an intra-base route CA and an inter-base route R is set, and a plurality of characters run the course is performed. For example, in a case where a course where the intra-base route CA1 is a starting point and the intra-base route CA2 is a goal point is set, a plurality of characters start from the starting point on the intra-base route CA1, pass through the inter-base route R1, and run to the goal point set on the intra-base route CA2.

In the exemplary embodiment, the player can execute a second racing game where the player character is caused to freely run on the field F. In the second racing game, the player can cause the player character to run along an intra-base route CA, also cause the player character to run along an inter-base route R, and also cause the player character to run through any position on the field different from an intra-base route CA and an inter-base route R. For example, in the second racing game, the player can also cause the player character to run on a ground where a road (a route) is not formed, a water surface, or the like. In the second racing game, a starting point and a goal point are not set. Also in the second racing game, the player character and a plurality of characters different from the player character move on the field. The second racing game is not a game where the characters compete on the carliness of reaching a goal as in the first racing game, but is a game where the characters run on the field, and therefore is included in the racing game in a broad sense.

The player selects which of the first racing game and the second racing game is to be executed, and executes the selected racing game. After the first racing game, the second racing game may be automatically performed. During the second racing game, the first racing game may be started.

Here, the modes of the game are described. In the exemplary embodiment, the player can perform the racing game in a single play mode where a single person performs the game and a multiplay mode where a plurality of people perform the game.

In the single play mode, a single player controls a player character (a vehicle object) using the controller 3 and/or the controller 4, and the processor 21 of the main body apparatus 2 controls one or more other characters (vehicle objects), whereby the racing game using a plurality of characters is performed.

The multiplay mode includes an offline multiplay mode and an online multiplay mode. The offline multiplay mode is a mode where a plurality of controllers are connected to a single main body apparatus 2, or a plurality of main body apparatuses 2 are connected together via a wireless or wired LAN or the like, and a plurality of players perform the game. The plurality of players control player characters (vehicle objects) relating to the plurality of players themselves using controllers.

In the online multiplay mode, a plurality of main body apparatuses 2 are connected to the Internet. Players control player characters relating to the players themselves using controllers. For example, each main body apparatus 2 connects to the Internet, receives information regarding (information indicating the positions, the orientations, the velocities, the moving directions, and the like of) the player characters relating to the other players directly or via a server. The main body apparatus 2 also transmits information regarding the player character relating to the player of the main body apparatus 2 itself to the other main body apparatuses 2 via a server or directly. Each main body apparatus 2 controls the player character relating to the player of the main body apparatus 2 itself and also controls the player characters relating to the other players based on the information received from the other main body apparatuses via a server or directly.

The first racing game and the second racing game according to the exemplary embodiment can be executed both in the single play mode and the multiplay mode, and processes described below can be executed in either game mode.

Next, an example of a base area is described, and an item in a first classification is also described. FIG. 5 is a diagram showing an example of the base area A1.

As shown in FIG. 5, in the base area A1, the intra-base route CA1 is provided. The intra-base route CA1 is a region where each character can move, and a road is formed along the route CA1. The intra-base route CA1 is connected to the inter-base route R1 and an inter-base route R3. The inter-base route R1 is a region where each character can move, and is joined to the base area A2. The inter-base route R3 is a region where each character can move, and is joined to the base area A4.

As shown in FIG. 5, in the intra-base route CA1, a plurality of building objects 70 are placed. Near each building object 70, a first item acquisition object for a character executing the racing game (the first racing game or the second racing game) to acquire an item in the first classification is placed. Along the intra-base route CA1, various obstacle objects other than the building objects 70 are placed. Each obstacle object is an object through which each character cannot pass (a building object different from the building objects 70, a wall object, or the like). A route where each character can run is formed by the obstacle object.

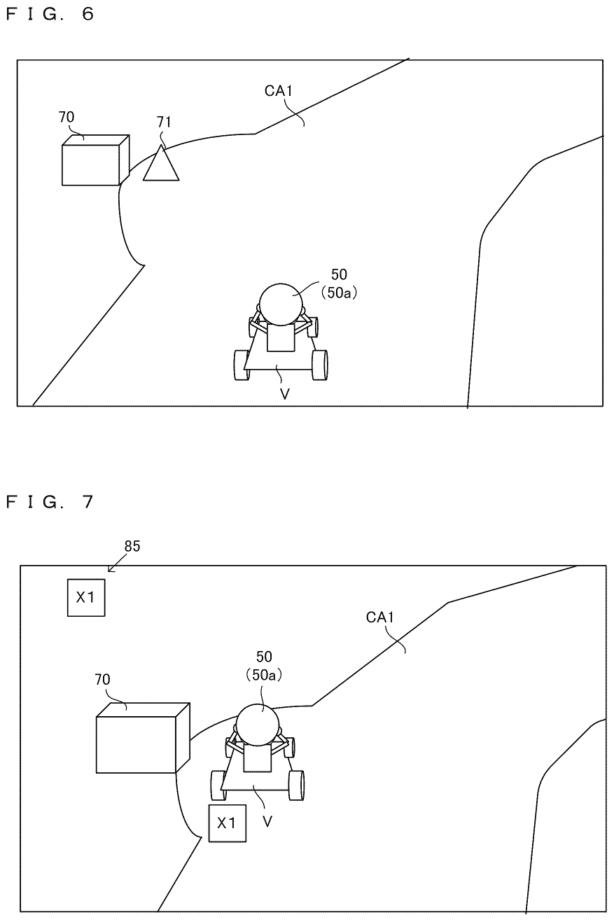

FIG. 6 is a diagram showing an example of a game image displayed during the first racing game or the second racing game and is a diagram showing an example of a game image displayed before the player character 50 acquires an item in the first classification. FIG. 7 is a diagram showing an example of a game image displayed after FIG. 6 and is a diagram showing an example of a game image displayed after the player character 50 acquires the item in the first classification.

As shown in FIG. 6, in accordance with an accelerator operation performed by the player, the player character 50 runs the intra-base route CA1 on a vehicle object V. Here, the character 50a is used as a player character. At a position a predetermined distance away from the player character 50a (e.g., a predetermined position behind the player character 50a), a virtual camera including the player character 50a in its imaging range is set. FIG. 6 shows a game image displayed when the racing game is performed in the single play mode or the online multiplay mode, and a game image based on the single virtual camera relating to the player character 50a is displayed. In a case where the game is performed in the offline multiplay mode, the screen is split into a plurality of regions, and a game image based on a virtual camera relating to each of a plurality of player characters is displayed in each region.

As shown in FIG. 6, if the player character 50a is running the intra-base route CA1, a building object 70 appears. Near the building object 70, a first item acquisition object 71 is placed.

The first item acquisition object 71 is an object for acquiring an item in the first classification. The first item acquisition object 71 is placed at a position set in advance on the intra-base route CA1. As shown in FIG. 7, when the player character 50 is running the intra-base route CA1, and if the player character 50 hits the first item acquisition object 71, the player character 50 acquires an item X1 that is an item in the first classification. For example, the item in the first classification may be an item representing food, and the item X1 may be an item representing particular food. If the player character 50 hits the first item acquisition object 71, the first item acquisition object 71 is temporarily erased, and after the lapse of a predetermined time, the first item acquisition object 71 appears at the same position again.

Specifically, if the player character acquires the item X1, the player character enters the state where the player character owns the item X1. If the player character owns the item X1, for example, the item X1 is displayed in an item stock region 85 at the upper left of the screen. The player character can simultaneously own a predetermined number of items, and the item stock region 85 displays the predetermined number of items owned by the player character. Among a plurality of items owned by the player character, an item in an implementable state is used in accordance with an instruction to use the item given by the player. The plurality of items owned by the player character enter the implementable state in the order of being owned. If an item in the implementable state is used in accordance with an instruction to use the item given by the player, an effect relating to the used item is implemented. In FIG. 7, the item X1 is in the implementable state, and the item X1 is displayed near the player character 50. If an instruction to use the item is given by the player in the state shown in FIG. 7, the item X1 is used.

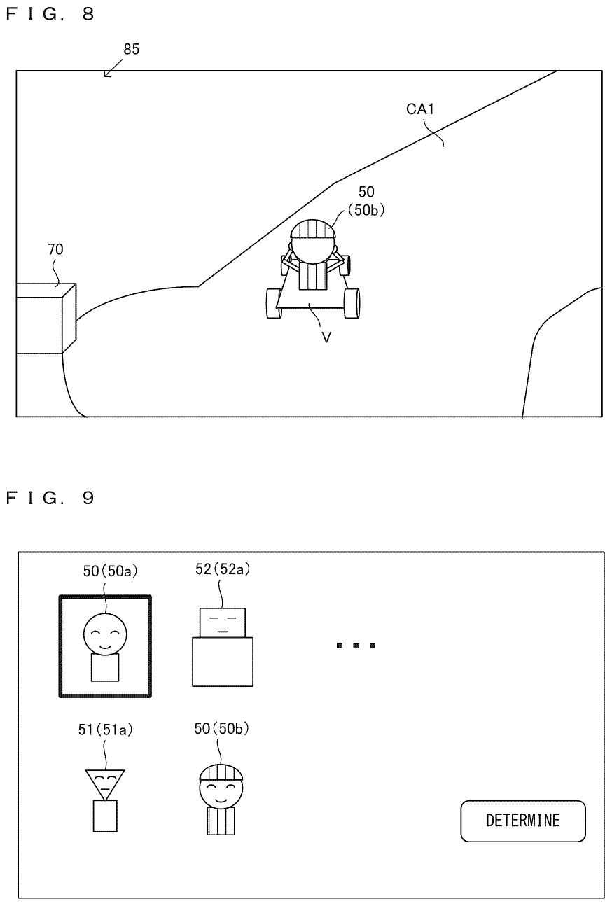

FIG. 8 is a diagram showing an example of a game image displayed after an instruction to use the item is given in FIG. 7.

If the player character uses the item X1, a first effect is produced. Specifically, as shown in FIG. 8, as the first effect, the player character 50 may change from the character 50a to the character 50b, which is the character 50 of the same type and different in costume. For example, the character 50b is the character 50 wearing clothes and a hat with vertical stripes. When the player character changes from the character 50a to the character 50b, the racing game is not suspended. For example, the player character changes from the character 50a to the character 50b without stopping while running.

If the item X1 is used, an effect regarding running may be further produced as the first effect. Specifically, the effect of accelerating the player character is produced as the effect regarding running relating to the item X1. Consequently, the velocity of the player character temporarily increases. When the effect regarding running is produced, for example, an effect image (not shown) indicating an increase in the velocity is displayed behind the vehicle object V that the player character is on. If the item X1 is used, the item X1 displayed on the periphery of the player character and in the item stock region 85 is erased.

In the exemplary embodiment, as items in the first classification, a plurality of items are prepared. Here, the items in the first classification are collectively referred to as “items X”, and in a case where any of the plurality of items in the first classification is identified, the item is referred to as an “item Xn” (n is a positive integer). In accordance with the type of a used item X and the type of a character that has used the item, a character as a change destination differs. In accordance with the location on the field F, an item X of a different type is placed. No matter which of the items X of the plurality of types is used, the effect regarding running is the same. The effect regarding running may differ in accordance with the type of the item X.

The player character may instantaneously switch from the character 50a to the character 50b, or may switch from the character 50a to the character 50b over a predetermined time. Meanwhile, the player character continues to run on the field so long as the accelerator operation continues. The timing when the player character switches from the character 50a to the character 50b and the timing when the velocity of the player character increases may not necessarily match each other.

After the player character changes from the character 50a to the character 50b, the racing game is continued using the player character 50b. While the player character 50b is running, and if the player character 50b further hits the first item acquisition object 71, the player character 50b may acquire another item X2. If the player character 50b uses the item X2, the player character 50b may further change to the character 50c of the same type and different in costume.

In a case where the player character changes from the character 50a to the character 50b, and if the character 50b is not set to selectable on the character selection screen, the character 50b is set to selectable. For example, if the player character 50 acquires and uses the item X1 during the first racing game, the character 50b is set to selectable on the character selection screen. In this case, after the first racing game ends (after the player character 50 reaches the goal point in the first racing game), the player can select the character 50b on the character selection screen. Then, if the character 50b is selected on the character selection screen, in accordance with an instruction to start the next racing game, the racing game using the player character 50b is started.

During the second racing game, the player can start the character selection screen. If the player character 50 acquires and uses the item X1 during the second racing game, the character 50b is set to selectable on the character selection screen. Then, if the player starts the character selection screen during the second racing game, the second racing game is suspended, and the character selection screen is displayed. The character selection screen displays the character 50b in a selectable manner. Then, if the character 50b is selected on the character selection screen, the second racing game is resumed using the player character 50b.

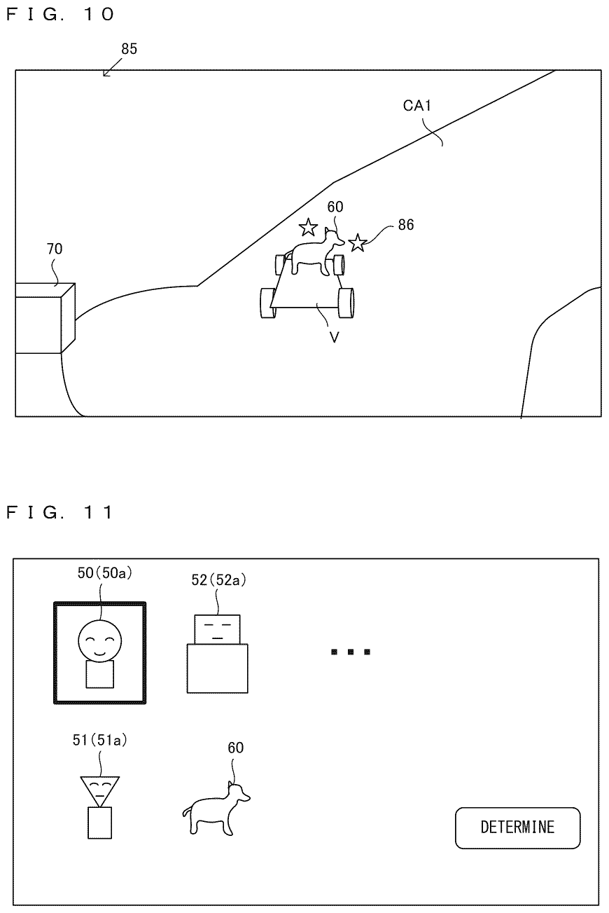

FIG. 9 is a diagram showing an example of a game image displayed when the character selection screen is displayed after the player character changes to the player character 50b based on the fact that the player character acquires the item X1 during the racing game.

As shown in FIG. 9, if the player character changes to the player character 50b based on the fact that the player character acquires the item X1 during the first racing game or the second racing game, the character 50b is displayed in a selectable manner on the character selection screen after that. On the character selection screen, the characters may be displayed in the order of being set to selectable, i.e., the order of being released. Selectable characters may be displayed with respect to each character type. The player may be allowed to set the order of selectable characters.

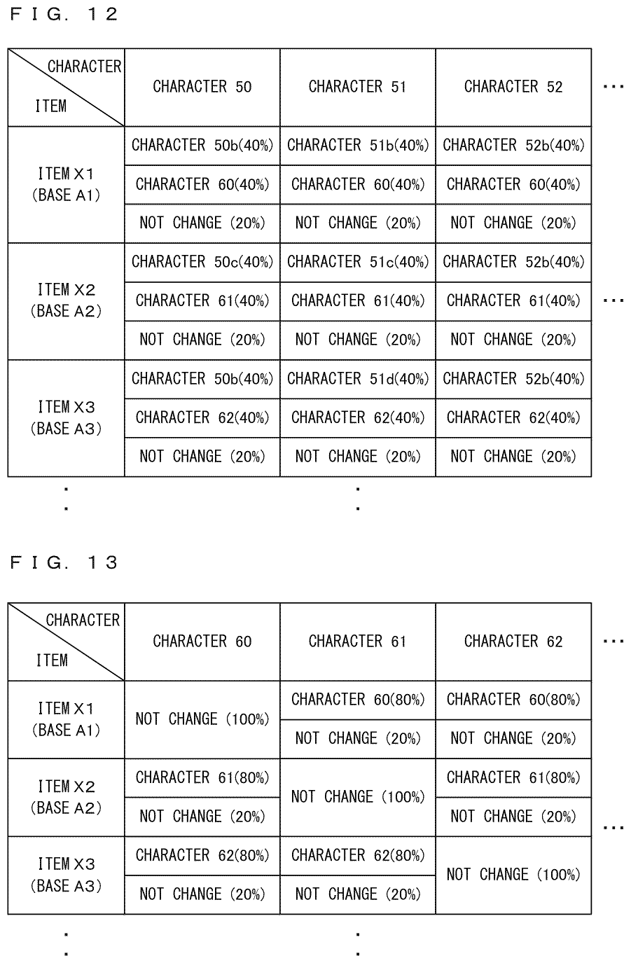

FIG. 10 is a diagram showing another example of a game image displayed after an instruction to use the item is given in FIG. 7.

As shown in FIG. 10, if the item X1 is used, the player character may change from the character 50a to a character 60 of another type. The character 60 is a character of the second type different from a character of the first type. For example, the character 60 may be a character representing a dog. If the player character changes to a character of the second type, an effect image 86 is displayed on the periphery of the player character. If the item X1 is used, similarly to FIG. 8, the effect regarding running (the effect of accelerating the player character) is produced.

If the player character changes to the character 60, a player character 60 is used in the racing game only for a predetermined time (e.g., several seconds to a dozen or two seconds). If the predetermined time elapses, the player character 60 returns to the previous player character 50a. As described above, even if the player character 50a changes to the character 60, which is a character of the second type, during the racing game, and if a predetermined period elapses, the character 60 returns to the player character 50a, and the racing game is continued.

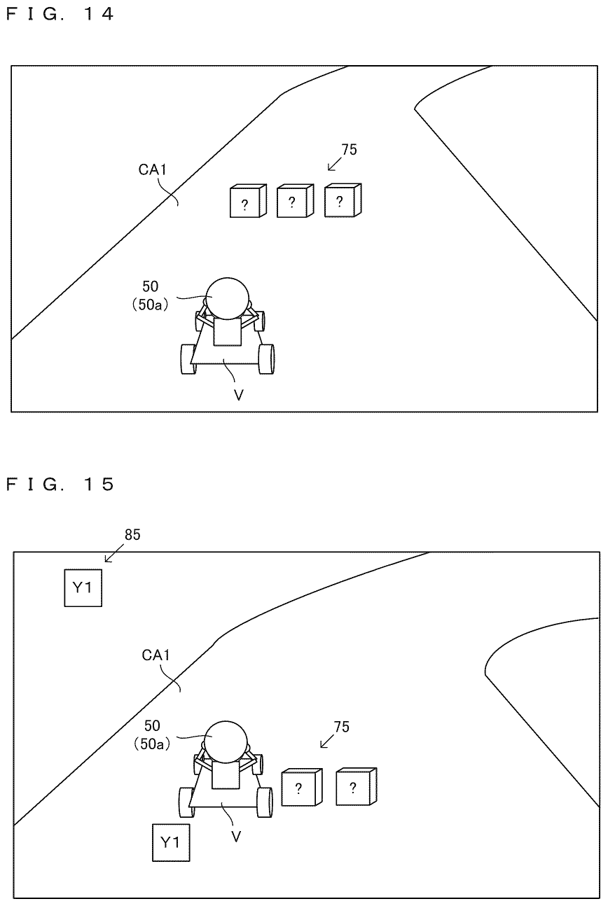

FIG. 11 is a diagram showing an example of a game image displayed when the character selection screen is displayed after the player character changes to the player character 60 based on the fact that the player character acquires the item X1 during the racing game.

As shown in FIG. 11, if the player character changes to the player character 60 based on the fact that the player character acquires the item X1 during the racing game, the character 60 is displayed in a selectable manner on the character selection screen.

As described above, if the player character 50a acquires the item X1 and uses the item X1 during the racing game, the player character 50a changes to the player character 50b, which is the character 50 of the same type and different only in external appearance (costume), or the character 60 of a type different from the character 50. Based on a predetermined probability, it is randomly determined which of the characters the player character 50a is to change.

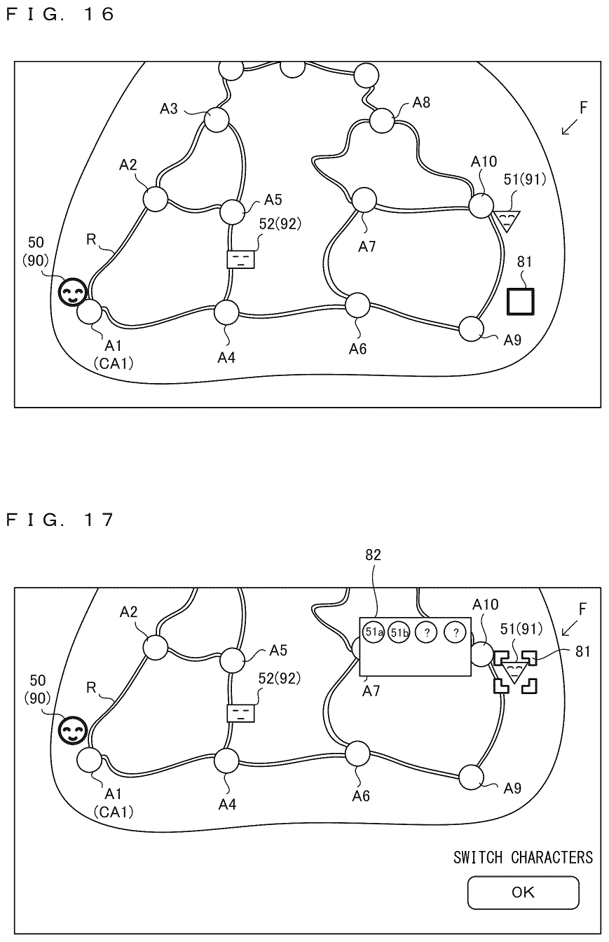

FIG. 12 is a diagram showing an example of the association between an item X and a character as a change destination of a character of the first type that has used the item X. FIG. 13 is a diagram showing an example of the association between an item X and a character as a change destination of a character of the second type that has used the item X.

The items X1 to Xn are placed at different positions on the field. For example, the item X1 is placed in the base area A1, the item X2 is placed in the base area A2, and the item X3 is placed in the base area A3. In this example, the items X are placed at predetermined positions on the intra-base routes CA. Specifically, as exemplified in FIG. 6, an item X is placed as the content of the first item acquisition object 71 near a predetermined building object on an intra-base route CA. The first item acquisition object 71 itself does not suggest the type of the item X that is the content, but the type of the item X may be suggested by the form of the building object. The first item acquisition object 71 itself may suggest the type of the item X that is the content.

As shown in FIG. 12, for example, if the character 50 uses the item X1, the character 50 changes to the character 50b, which is a character of the same type and different in costume, with a probability of 40%, changes to the character 60 of a different type with a probability of 40%, and does not change with a probability of 20%. If the character 51 uses the item X1, the character 51 changes to the character 51b with a probability of 40%, changes to the character 60 with a probability of 40%, and does not change with a probability of 20%. If the character 52 uses the item X1, the character 52 changes to the character 52b with a probability of 40%, changes to the character 60 with a probability of 40%, and does not change with a probability of 20%.

If the character 50 uses the item X2, the character 50 changes to the character 50c with a probability of 40%, changes to a character 61 with a probability of 40%, and does not change with a probability of 20%. If the character 51 uses the item X2, the character 51 changes to the character 51c with a probability of 40%, changes to the character 61 with a probability of 40%, and does not change with a probability of 20%. If the character 52 uses the item X2, the character 52 changes to the character 52b with a probability of 40%, changes to the character 61 with a probability of 40%, and does not change with a probability of 20%.

If the character 50 uses the item X3, the character 50 changes to the character 50b with a probability of 40%, changes to a character 62 with a probability of 40%, and does not change with a probability of 20%. If the character 51 uses the item X3, the character 51 changes to the character 51d with a probability of 40%, changes to the character 62 with a probability of 40%, and does not change with a probability of 20%. If the character 52 uses the item X3, the character 52 changes to the character 52b with a probability of 40%, changes to the character 62 with a probability of 40%, and does not change with a probability of 20%.

Even if an item X is used, there is a case where the player character does not change. For example, when the racing game is performed using the player character 50b, and if the player character 50b uses the item X1 and the character 50b is selected or “not change” is selected based on the correspondence table shown in FIG. 12, the player character 50b does not change. Also in this case, the effect regarding running relating to an item X is produced.

If the player character changes to a character of the second type using an item X during the racing game, the character of the second type is set to selectable on an item selection screen. The player can select the character of the second type set to selectable on the item selection screen and perform the racing game. Some of a plurality of characters of the second type may be initially set to selectable on the item selection screen. During the racing game, in a case where the player character is a character of the second type without the character different in costume, and if an item X is used, the player character changes with a probability shown in FIG. 13.

As shown in FIG. 13, for example, if the character 60 uses the item X1, the character 60 does not change. If the character 61 uses the item X1, the character 61 changes to the character 60 with a probability of 80%, and does not change with a probability of 20%. If the character 62 uses the item X1, the character 62 changes to the character 60 with a probability of 80%, and does not change with a probability of 20%.

If the character 60 uses the item X2, the character 60 changes to the character 61 with a probability of 80%, and does not change with a probability of 20%. If the character 61 uses the item X2, the character 61 does not change. If the character 62 uses the item X2, the character 62 changes to the character 61 with a probability of 80%, and does not change with a probability of 20%.

If the character 60 uses the item X3, the character 60 changes to the character 62 with a probability of 80%, and does not change with a probability of 20%. If the character 61 uses the item X3, the character 61 changes to the character 62 with a probability of 80%, and does not change with a probability of 20%. If the character 62 uses the item X3, the character 62 does not change.

Both in a case where a character as a change destination is not set to selectable on the character selection screen and in a case where a character as a change destination is set to selectable on the character selection screen, and if the player character uses an item X, the player character changes to a character as a change destination with a probability shown in FIG. 12 or 13.

For example, in a case where the game is performed in the single play mode, the racing game is performed using a player character and a plurality of characters controlled by the processor 21. In a case where the game is performed in the multiplay mode, there is a case where the racing game is performed using a plurality of player characters and a plurality of characters controlled by the processor 21. For example, in a case where the game is performed in the multiplay mode, and if a player character controlled by a first player uses an item X, the player character of the first player changes to a character as a change destination shown in FIGS. 12 and 13. In this case, the first player is newly allowed to select the character to which the player character has changed on the character selection screen. On the other hand, in a case where a character of another player who is an opponent changes to another character using an item X in the online multiplay mode, the first player is not newly allowed to select the character to which the character has changed on the character selection screen. In the offline multiplay mode by a first player and a second player, if a character of the second player changes to another character using an item X, the first player may or may not be newly allowed to select the character to which the character has changed on the character selection screen. If a character controlled by the processor 21 uses an item X, the character may change to a character as a change destination shown in FIGS. 12 and 13. In this case, the character as the change destination to which the character has changed is not set to selectable on the character selection screen. If the character controlled by the processor 21 uses an item X, the character may not change to a character as a change destination shown in FIGS. 12 and 13.

No matter which item X is used, there is a case where the effect regarding running to be implemented with the change of the character is the same, but the degree of the effect differs.

Specifically, there are a plurality of display forms for each of the items X1 to Xn, and the degree of the effect regarding running differs in accordance with the display form. For example, there are “large”, “medium”, and “small” as the magnitude of the effect for the item X1. In a case where the item X1 for which the magnitude of the effect is “large” is used, the effect regarding running may continue longer than in a case where the item X1 for which the magnitude of the effect is “medium” is used. For example, in a case where the item X1 for which the magnitude of the effect is “large” is used, the player character may be accelerated for a longer time than in a case where the item X1 for which the magnitude of the effect is “medium” is used. Which of “large”, “medium”, and “small” is acquired by the player character may be randomly determined with a probability relating to the ranking of the player character when the player character uses or acquire an item X. For example, the lower the ranking of the player character is, the more likely the item X1 for which the magnitude of the effect is “large” (the item X1 for which the effect regarding running is great) may be to be acquired by the player character. The display forms relating to “large”, “medium”, and “small” may be different appearances, or may be forms different in size with a common appearance. If an item X is the appearance of a dish, the greater the effect of the item is, the larger the helping may be, or the more sumptuous the dish may be. In the first racing game, the likelihood of the emergence of “large”, “medium”, and “small” may be changed in accordance with the current ranking of the player character. For example, if the ranking is high (e.g., if the player character ranks first or second), an item X for which the magnitude of the effect is “small” may be likely to be acquired by the player character, and if the ranking is low, an item X for which the magnitude of the effect is “large” may be likely to be acquired by the player character.

The probabilities shown in FIGS. 12 and 13 are merely examples, and may be appropriately changed. For example, the probabilities may be set so that a character that has used an item changes. The probabilities shown in FIGS. 12 and 13 may dynamically change. For example, the selection probability of a character that has not yet been set to selectable may be set to be high, and the selection probability of a character already set to selectable may be set to be low. If characters as change destinations are all set to selectable, the probability of “not change” may be set to be high.

The type of a character that has used an item X and characters as change destinations different in costume may be associated in a one-to-many manner. For example, the character 50 may be set so that if the character 50 uses the item X1, the character 50 can change to any of the characters 50b, 50c, 60, and 61.

The positions where the items X are placed are merely examples, and the items X may be placed at other positions on the field. Items X of a plurality of types may be placed in a single base, and the player character may be able to acquire items X of a plurality of types on a single intra-base route CA. There may be an item X placed on an inter-base route R, and the player character may be able to acquire the item while running the inter-base route R. The position where an item X is placed may dynamically change. For example, a moving body controlled by the processor 21 may be running an intra-base route CA or an inter-base route R, and an item X may move with the running moving body. If the player character comes into contact with the moving body, the player character may acquire the item X.

In the above exemplary embodiment, the location where the first item acquisition object 71 is placed and an item X of a single type are associated with each other, and if the player character hits the first item acquisition object 71, the player character acquires an item X of a type relating to the location where the first item acquisition object 71 is placed. In another exemplary embodiment, if the player character hits the first item acquisition object 71, in accordance with the location where the first item acquisition object 71 is placed, any of items X of a plurality of types may be randomly determined. For example, if the player character hits the first item acquisition object 71 placed in the base area A1, the item X1 or X2 may be randomly determined and acquired by the player character. If the player character hits the first item acquisition object 71 placed in the base area A2, the item X3 or X4 may be randomly determined and acquired by the player character.

As described above, in the exemplary embodiment, the player character can change to a character of the same type and different in costume or to a character of another type by using an item X. If the player character changes, the character to which the player character has changed is selectable on the character selection screen after that. An item X of a different type is placed in accordance with the location on the field, and based on the type of an item X and the type of a player character that has used the item X, a character as a change destination is set. Even if the player character uses an item X, there is also a case where the player character does not change.

Consequently, while the player character is running in the racing game (the first racing game or the second racing game), it is possible to change the player character without suspending the game. If the player character changes, a character as a change destination is set to selectable on the character selection screen. Thus, the player can increase selectable characters while running. The type of an item X and a character as a change destination are associated with each other, and an item X of a different type is placed in accordance with the location on the field. Thus, the player character can change its appearance while running through various locations on the field. The player can also increase selectable characters while running through various locations on the field.

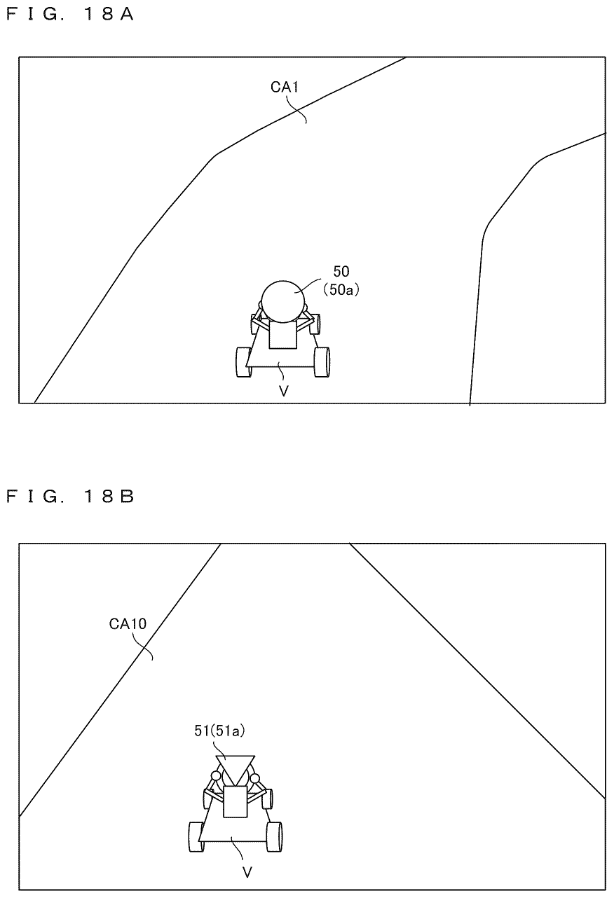

Next, an item in a second classification is described. FIG. 14 is a diagram showing examples of second item acquisition objects 75 placed on the field. FIG. 15 is a diagram showing an example of a game image displayed when the player character hits the second item acquisition objects 75 and acquires an item in the second classification.

For example, on an intra-base route CA or an inter-base route R on the field, a plurality of second item acquisition objects 75 are placed. As shown in FIG. 14, for example, a plurality of second item acquisition objects 75 are placed at a plurality of positions on the intra-base route CA1. Each second item acquisition object 75 is an object for causing a character performing the racing game to acquire an item in the second classification.

As shown in FIG. 15, for example, if the player character 50 hits the second item acquisition objects 75, an item in the second classification (referred to as an “item Y”) is acquired by the player character 50. As items in the second classification, items Y of a plurality of types (e.g., items Y1 to Ym) are prepared. If the player character 50 hits the second item acquisition objects 75, any of the items Y of the plurality of types is randomly determined. If the player character 50 hits the second item acquisition objects 75, the second item acquisition objects 75 are temporarily erased, and after the lapse of a predetermined time, the second item acquisition objects 75 appear at the same position again.

An item Y in the second classification produces a second effect when the item is used. In accordance with the type of the item Y, an effect that differs is produced. For example, the item Y1 has the effect of temporarily increasing the velocity of the character that has used the item as the second effect. For example, the item Y2 has an attack effect on a character different from the character that has used the item as the second effect. If the player character uses the item Y2, the item Y2 is shot in the forward direction of the player character. If the shot item Y2 hits a character going ahead of the player character, the character temporarily stops, or the velocity of the character temporarily decreases. Items having various effects are prepared as the items Y in addition to these items.

These items Y of the plurality of types include an item having a great effect and an item having a small effect. If the player character hits the second item acquisition objects 75, the type of an item Y to be given to the player character differs in accordance with the situation of the game. Specifically, if the first racing game is performed by a plurality of characters including the player character, the type of an item Y to be acquired is randomly determined in accordance with the current ranking of the character. For example, in a case where the current ranking of the player character is high (e.g., the player character ranks first or second), and if the player character hits the second item acquisition objects 75, an item Y having a relatively small effect is likely to be acquired by the player character. On the other hand, in a case where the current ranking of the player character is low, and if the player character hits the second item acquisition objects 75, an item Y having a relatively great effect is likely to be acquired by the player character.

Here, as shown in FIG. 15, the player character 50 acquires the item Y1. The item Y1 produces an effect regarding running similar to that when the player character uses an item X. For example, if the player character 50 uses the item Y1, the velocity of the player character 50 temporarily increases.

In addition to the effect of temporarily increasing the velocity, the item Y1 also has another effect that an item X does not have. For example, the item Y1 may have the effect of avoiding an attack that uses the item Y2. For example, if the item Y2 is shot from another character following the player character, normally, the item Y2 hits the player character going ahead of another character, and the player character temporarily stops, or the velocity of the player character decreases. If, on the other hand, the item Y1 is used at the timing when the item Y2 hits the player character, this attack that uses the item Y2 is nullified. An item X does not have such an effect of nullifying an attack that uses the item Y2. On the other hand, an item Y does not have the effect of changing another character as in an item X.

As described above, in the above exemplary embodiment, an item X has some of the plurality of effects of the item Y1 as the effect regarding running. In another exemplary embodiment, an item X may have all of the plurality of effects of the item Y1 as the effect regarding running.

### (Switching of Character)

Next, the switching of the player character is described. As described above, the racing game according to the exemplary embodiment is performed using the broad field F. On the field F, a plurality of base areas A are provided. In each base area A, an intra-base route CA is provided. An inter-base route R connecting base areas is provided. In the second racing game, the player character can freely run on the field. For example, the player character can run the intra-base route CA and the inter-base route R and run through any position on the field where a route is not set.

During the execution of the second racing game, the player character is controlled on the field based on an operation input provided by the player, and a plurality of playable characters are also automatically controlled at locations on the field.

While the player character 50 is running, the positions of other characters of the first type (51, 52, and the like) are also automatically updated. For example, when the player is causing the player character 50 to run through a first location on the field, the character 51 (e.g., the character 51a) moves through a second location on the field, and the character 52 (e.g., the character 52a) moves through a third location on the field. If the player character 50 moves to the second location, the player character 50 may encounter the character 51.

During the execution of the second racing game as described above, the player can display a map UI indicating a wide range in the field. In the exemplary embodiment, during the display of the map UI, the second racing game is suspended, and the positions of all the characters are not updated.

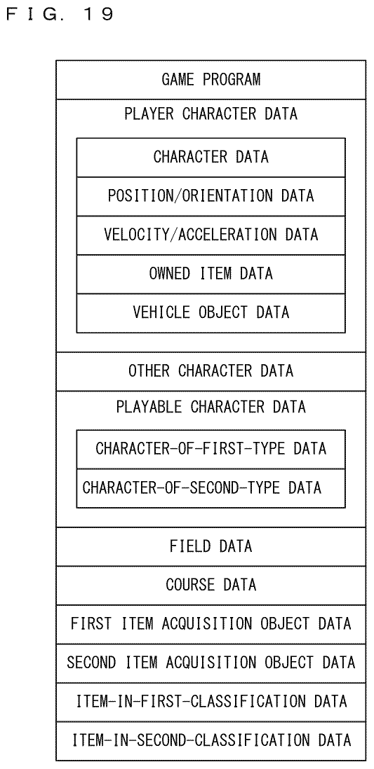

FIG. 16 is a diagram showing an example of a map UI displayed in a case where the player performs a predetermined operation during the execution of the second racing game. FIG. 17 is a diagram showing an example of an image displayed when the character 51 is selected in the map UI.

For example, if a predetermined operation for displaying a map UI (e.g., the pressing of the Y-button) is performed while the player character 50 is running in the second racing game, a map UI as shown in FIG. 16 is displayed. The map UI is a user interface using a map image representing a part or the entirety of the field F.

The map UI displays a map image, an icon indicating the position on the field of the player character, and icons indicating the positions on the field of characters of the first type controlled by the processor 21. In the exemplary embodiment, in the second racing game, a character of the second type is also automatically controlled on the field, and the player character may encounter the character of the second type. The map UI, however, does not display an icon indicating the position on the field of the character of the second type.

For example, the map UI shown in FIG. 16 includes a map image, an icon 90 indicating the position on the field of the player character 50, an icon 91 indicating the position on the field of the character 51, and an icon 92 indicating the position on the field of the character 52. The map UI also includes a cursor 81 for indicating a position. The player can indicate a position on the map image, indicate an icon indicating each character, or change the region of the field F to be displayed as the map image, for example, by operating the cursor 81 using the analog stick.

With the map UI, the player can grasp the position of each character. For example, it is understood that the player character 50 is currently located in the base area A1, the character 51 is located in the base area A10, and the character 52 is located between the base area A4 and the base area A5.

As shown in FIG. 17, if the player moves the cursor 81 to the position of the icon 91 indicating the character 51, the display form of the cursor 81 changes. At this time, information display 82 is displayed. The information display 82 displays information indicating characters selectable on the character selection screen as the character 51 indicated by the cursor 81. For example, as the information display 82, icon images of characters set to selectable are displayed. For example, in FIG. 17, an icon image indicating the character 51a and an icon image indicating the character 51b are displayed. The information display 82 displays the number of characters of the same type and different in costume that are not set to selectable (the number of characters that are not released) in a recognizable manner. For example, in FIG. 17, two icon images with a “?” mark are displayed. This indicates that there are two characters different in costume that are not set to selectable. If a button for giving an instruction to make a determination (e.g., the A-button) is pressed at this time, an OK button for confirmation as shown at the lower right of FIG. 17 is displayed.

In a case where the OK button is displayed as shown in FIG. 17, and if a determination button (e.g., the A-button) is further pressed, the player character is changed from the character 50 to the character 51 (e.g., the character 51a), and the second racing game is resumed from the position of the character 51 indicated by the cursor 81. If the player character is changed from the character 50 to the character 51, the character 50 is placed at a position set in advance on the field and becomes a character controlled by the processor 21.

FIG. 18A is a diagram showing an example of a game image displayed when the second racing game is executed using the player character 50a immediately before the map UI is displayed. FIG. 18B is a diagram showing an example of a game image displayed when the second racing game is resumed by changing the player character from the character 50a to the character 51a in the map UI.

When the player character 50a is running the intra-base route CA1 as shown in FIG. 18A, and if a predetermined operation for displaying the map UI is performed, the map UI is displayed. If the icon 91 relating to the character 51 is indicated and the OK button is pressed in the map UI, as shown in FIG. 18B, the player character is changed from the character 50a to the character 51a, and the second racing game is also resumed from the position of the character 51a. Specifically, if the character 51a is present at a particular position on an intra-base route CA10 immediately before the map UI is displayed, the second racing game is resumed from the particular position on the intra-base route CA10.

With the change of the player character from the character 50 to the character 51a, the vehicle object V may also be changed in accordance with the character 51 as the change destination. While the player character is changed from the character 50 to the character 51a, the vehicle object V may not be changed.

The character 51 as the change destination is the character 51a set in advance. The character 51 as the change destination may be any of a plurality of characters different in costume that are set to selectable. For example, any of a plurality of characters different in costume that are set to selectable may be randomly selected.

The player can also change only the position of the player character without changing the player character in the map UI shown in FIGS. 16 and 17. Specifically, the player specifies any of the plurality of base areas A in the map image using the cursor 81 and presses the determination button and thereby can move the player character to the specified base area. In this case, the player character and the vehicle object V do not change.

When the player is causing the player character to run on the field in the second racing game, the player can also change the player character using the above character selection screen. Specifically, when the player character is running on the field in the second racing game, and if a predetermined operation for displaying the character selection screen is performed, the second racing game is suspended, and the character selection screen is displayed. The player selects any of a plurality of playable characters on the character selection screen and presses the “determine” button. Consequently, the player character is changed, and the second racing game is resumed from the position of the player character before the suspension.

As described above, in the second racing game according to the exemplary embodiment, the player character moves on the field based on an operation input provided by the player, and a plurality of other characters controlled by the processor 21 also automatically move on the field. The player can change the player character to another character using the map UI and also resume the second racing game from the position of the other character. As described above, it is possible to move another character at various locations on the field in addition to the player character, change the player character to the other character, and also move the player character to the position of the other character. Consequently, the player can perform a racing game using various characters at various locations on a broad field.

The player can start the character selection screen during the execution of the second racing game and change the type of the character without changing the position of the player character. Consequently, the player can perform a racing game using various characters at the current positions.

The player can specify a position in the map image during the execution of the second racing game and thereby can move the player character to the specified position. Consequently, the player can perform a racing game at various locations using the same player character.

### (Details of Game Processes)

Next, the details of game processes performed by the game system 1 are described.

FIG. 19 is a diagram showing examples of various pieces of data used in the game processes performed by the game system 1. As shown in FIG. 19, a memory (e.g., the DRAM 27, a storage medium attached to the slot 29, or the flash memory 26) of the game system 1 stores a game program, player character data, other character data, playable character data, field data, course data, first item acquisition object data, second item acquisition object data, item-in-first-classification data, and item-in-second-classification data.

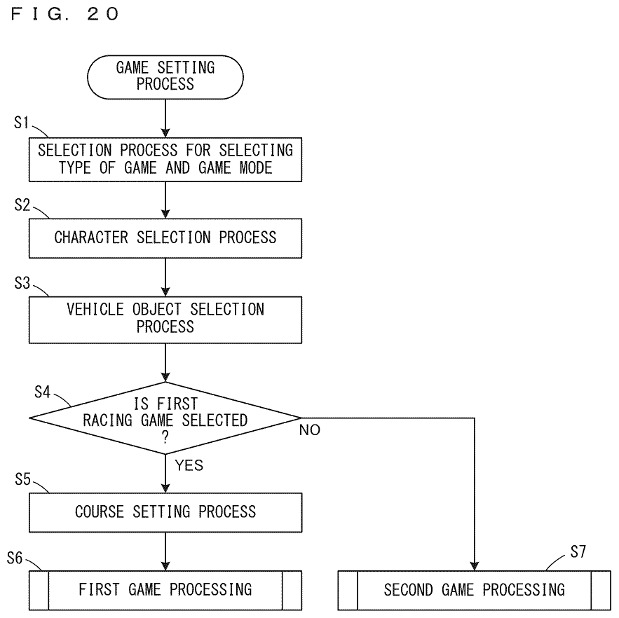

The game program is a program for executing the game processes according to the exemplary embodiment (processes shown in FIGS. 20 to 25 described below). The game program is stored in advance in the storage medium attached to the slot 29 or the flash memory 26 and is loaded into the DRAM 27 when the racing game is executed.

The player character data is data regarding a player character controlled by the player of the main body apparatus 2. The player character data includes character data, position/orientation data indicating the position and the orientation of the player character, and velocity/acceleration data indicating the velocity and the acceleration of the player character. The character data includes 3D model data and texture data indicating the shape and the external appearance of the character, data indicating the characteristics of the character, and the like. The player character data also includes owned item data regarding items owned by the player character, and vehicle object data indicating a vehicle object that the player character is on.

The other character data is data regarding other characters that perform the racing game with the player character in the first racing game or the second racing game. The other characters are controlled by other players or the processor 21. The other character data includes data similar to the player character data.

The playable character data is data regarding each of a plurality of characters stored in advance and includes character-of-first-type data and character-of-second-type data.

The character-of-first-type data includes character data (3D model data, texture data, data indicating the characteristics, and the like) regarding each of the above plurality of characters of the first type (e.g., 50a to 50c, 51a to 51d, and 52a and 52b). The character-of-first-type data also includes a selectability flag indicating whether or not each of the plurality of characters of the first type is set to selectable on the character selection screen.

The character-of-second-type data includes character data (3D model data, texture data, data indicating characteristics, and the like) regarding each of the above plurality of characters of the second type (e.g., 60 to 62). The character-of-second-type data also includes a selectability flag indicating whether or not each of the plurality of characters of the second type is set to selectable on the character selection screen.

The field data is data indicating the entirety of the field F. The field data includes data indicating a plurality of base areas and data indicating a plurality of inter-base routes.

The course data is data that defines a course where the first racing game is performed. For example, the course data includes course objects (e.g., a road, a wall, a building object, and the like) that define the course. In the exemplary embodiment, a plurality of courses are prepared in advance, and course data relating to each course is stored in the memory. The course data may be stored in advance in the storage medium or the flash memory 26 attached to the slot 29, or may be acquired from the server via the Internet, or may be acquired from another main body apparatus 2.

The first item acquisition object data is data regarding the first item acquisition object 71 placed at a predetermined position on an intra-base route CA or an inter-base route R and includes data indicating the placement position, data indicating the shape, and the like.

The second item acquisition object data is data regarding the second item acquisition objects 75 placed at a predetermined position on an intra-base route CA or an inter-base route R and includes data indicating the placement position, data indicating the shape, and the like.

The item-in-first-classification data is data regarding an item X in the first classification. The item-in-first-classification data includes data indicating the shape of each of a plurality of items X and data indicating an effect when each of the plurality of items X is used. The item-in-second-classification data is data regarding an item Y in the second classification. The item-in-second-classification data includes data indicating the shape of each of a plurality of items Y and data indicating an effect when each of the plurality of items Y is used.

### (Game Setting Process)

Next, the processes performed by the game system 1 are described. FIG. 20 is a flow chart showing an example of a game setting process performed when an instruction to execute the game program is given. The game setting process shown in FIG. 20 is a process executed in accordance with the fact that an instruction to start the game is given by the player, and is a process for setting the type of the game (the first racing game or the second racing game), a course, the game mode (the single play mode, the offline multiplay mode, or the online multiplay mode), the type of the player character, the type of the vehicle object, and the like based on an input provided by the player.

In the exemplary embodiment, the description is given on the assumption that the processes of steps shown in FIGS. 20 to 25 are executed by the processor 21 of the main body apparatus 2 executing the game program using a memory (e.g., the DRAM 27). In another exemplary embodiment, however, some of the processes of the steps may be executed by a processor (e.g., a dedicated circuit or the like) different from the processor 21. In a case where the game system 1 can communicate with another information processing apparatus (e.g., a server), some of the processes of the steps may be executed by the other information processing apparatus. The processes of all of the steps are merely illustrative. Thus, the processing order of the steps may be changed, or another process may be performed in addition to (or instead of) the processes of all of the steps, so long as similar results are obtained.

As shown in FIG. 20, the processor 21 performs a selection process for selecting the type of the game and the game mode (step S1). Here, the processor 21 displays a setting screen for allowing the player to select any of a plurality of types of games including the first racing game and the second racing game and receives an operation input from the player. In accordance with the operation input from the player, the processor 21 selects the type of the game to be executed. If the first racing game is selected, the processor 21 displays a course selection screen and allows the player to select a course where the first racing game is to be performed. The processor 21 also displays a setting screen for allowing the player to select the game mode and receives an operation input from the player. In accordance with the operation input from the player, the processor 21 sets the game mode.

If the type of the game and the game mode are selected, the processor 21 performs a character selection process (step S2). The character selection process is a process for allowing the player to select a player character. Specifically, the processor 21 displays the character selection screen as shown in FIG. 3 and receives an operation input from the player. In accordance with the operation input from the player, the processor 21 sets the player character.

If the player character is selected, the processor 21 performs a vehicle object selection process (step S3). The vehicle object selection process is a process for allowing the player to select a vehicle object that the player character is on. The processor 21 displays a vehicle object selection screen and receives an operation input from the player. In accordance with the operation input from the player, the processor 21 sets the vehicle object.

If the vehicle object is selected, the processor 21 determines whether or not the first racing game is selected in step S1 (step S4).

If the first racing game is selected (step S4: YES), the processor 21 performs a course setting process (step S5). In the course setting process, the course selected in step S1 is set. Consequently, a movement range where a plurality of characters including the player character move along a predetermined path is set. Specifically, in accordance with the selected course, a starting point and a goal point are set, and the path from the starting point to the goal point is set.

If the course setting process is performed, the processor 21 starts first game processing regarding the first racing game (step S6). The first game processing is repeatedly performed until the first racing game ends.

If, on the other hand, the second racing game is selected (step S4: NO), the processor 21 starts second game processing regarding the second racing game (step S7). The second game processing is repeatedly performed until the second racing game ends.

### (First Game Processing)

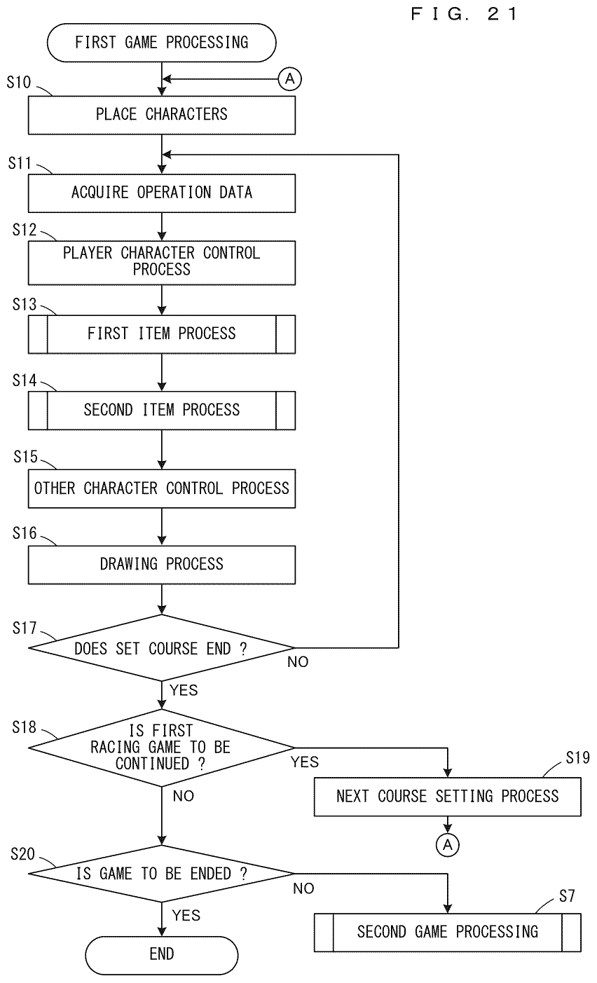

FIG. 21 is a flow chart showing an example of the first game processing. For example, the first game processing is executed in a case where the first racing game is selected in the above game setting process and an instruction to start the game is given.

First, the processor 21 places the player character of the type selected in the character selection process and other characters at the starting point on the set course (step S10). Here, the player character 50a is selected in the character selection process. After the characters are placed, the first racing game is started, and the processes of next step S11 and subsequent steps are executed.

If the first racing game is started, in step S11, the processor 21 acquires operation data. Specifically, the processor 21 acquires the operation data from the controllers 3 and 4 that is stored in the memory. From this point onward, the processor 21 repeatedly executes the processes of steps S11 to S17 at predetermined frame time intervals (e.g., 1/60-second intervals). Next, the processor 21 executes a player character control process (step S12).

Here, based on the operation data, the processor 21 updates the position, the orientation, the velocity (the moving direction and the velocity), and the like of the player character and causes the player character to perform a predetermined action. In accordance with the update of the position of the player character, the processor 21 also updates the position of the virtual camera. If the player character is changed to a character of the second type based on the acquisition of an item X in the first classification (step S25 described below), in step S12, the processor 21 determines whether or not a predetermined time elapses since the change to the character of the second type. If the predetermined time elapses since the change to the character of the second type, the processor 21 changes back the player character from the character of the second type to the character before the change stored in step S25.

Next, the processor 21 performs a first item process (step S13). The first item process is a process regarding the first item acquisition object 71 and an item in the first classification. Specifically, the first item process is a process of causing the player character to acquire an item in the first classification in accordance with the fact that the player character hits the first item acquisition object 71, or changing the player character in accordance with the fact that the player character uses an item in the first classification. The details of the first item process are described below.

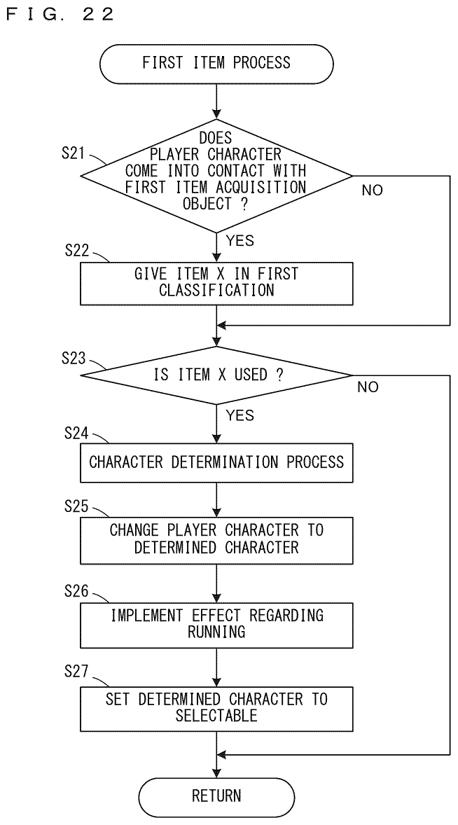

FIG. 22 is a flow chart showing an example of the first item process in step S13.

As shown in FIG. 22, based on the position of the player character updated in step S12, the processor 21 determines whether or not the player character comes into contact with the first item acquisition object 71 (step S21).

If the player character comes into contact with the first item acquisition object 71 (step S21: YES), the processor 21 gives an item X in the first classification to the player character (step S22). The type of the item X to be given here is set in accordance with the position where the first item acquisition object 71 is placed on the field. Consequently, the player character acquires an item X of a type relating to the current position. The type of the item X to be given may be randomly determined based on the position of the first item acquisition object 71.

If the determination is NO in step S21, or if the process of step S22 is executed, based on the operation data, the processor 21 determines whether or not the player character uses the item X owned by the player character (step S23). Specifically, the processor 21 determines whether or not an instruction to use the item is given when the item X is in the implementable state.

If the player character uses the item X (step S23: YES), the processor 21 executes a character determination process (step S24). Here, based on the type of the used item X and the type of the current player character, the processor 21 determines a character as a change destination. Specifically, based on the correspondence table shown in FIG. 12 or 13, the processor 21 randomly determines the character as the change destination.

Next, the processor 21 changes the current player character to the character determined in step S24 (step S25). Specifically, the processor 21 switches the character data in the player character data to the character data relating to the determined character. If a character of the second type is determined in step S24, the processor 21 stores the character before the change. As described above, in step S12, if a predetermined time elapses since the change to the character of the second type, the player character is changed back from the character of the second type to the character before the change. If, on the other hand, the player character is changed to a character of the first type in step S25, and even if the predetermined time elapses, the player character is not changed back to the character before the change.

Next, the processor 21 implements the effect regarding running (step S26). For example, the processor 21 temporarily increases the velocity of the player character as the effect regarding running.

Next, if the character determined in step S24 is not set to selectable on the character selection screen, the processor 21 sets the determined character to selectable (step S27). Specifically, the processor 21 sets the selectability flag (the flag included in the playable character data) of the character determined in step S24 to ON.

If the process of step S27 is executed, or if the determination is NO in step S23, the processor 21 ends the process shown in FIG. 22, and the processing returns to FIG. 21.

Referring back to FIG. 21, after step S13, the processor 21 executes a second item process (step S14). The details of the second item process are described below.

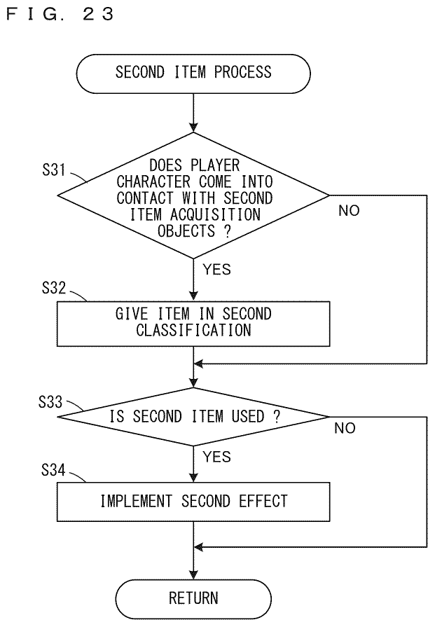

FIG. 23 is a flow chart showing an example of the second item process in step S14.

As shown in FIG. 23, based on the position of the player character updated in step S12, the processor 21 determines whether or not the player character comes into contact with the second item acquisition objects 75 (step S31).

If the player character comes into contact with the second item acquisition objects 75 (step S31: YES), the processor 21 gives an item Y in the second classification to the player character (step S32). The type of the item Y to be given here is randomly determined with a probability relating to the current ranking of the player character. Consequently, the player character acquires an item Y.

If the determination is NO in step S31, or if the process of step S32 is executed, based on the operation data, the processor 21 determines whether or not the player character uses the item Y owned by the player character (step S33). Specifically, the processor 21 determines whether or not an instruction to use the item is given when the item Y is in the implementable state.

If the determination is YES in step S33, the processor 21 implements the second effect relating to the type of the used item Y (step S34). For example, if the item Y1 is used, the processor 21 temporarily increases the velocity of the player character as the second effect relating to the item Y1. If a predetermined attack is made on the player character by another character at the timing when the item Y1 is used, the processor 21 nullifies the predetermined attack as the second effect relating to the item Y1. If an item Y of another type is used, the second effect relating to the type of the used item Y is implemented.

If the process of step S34 is executed, or if the determination is NO in step S33, the processor 21 ends the process shown in FIG. 23, and the processing returns to FIG. 21.

Referring back to FIG. 21, after step S14, the processor 21 executes an other character control process (step S15). Here, a process regarding the other characters that perform the racing game with the player character is performed. Specifically, the processor 21 updates the position, the orientation, the velocity (the moving direction and the velocity), and the like of each of the plurality of other characters, or causes each of the plurality of other characters to perform a predetermined action. In the other character control process, processes similar to the above first item process and second item process are performed. For example, if another character uses an item X in the first classification, an effect regarding the item X (the change of the character and the effect regarding running) is produced. If another character uses an item Y in the second classification, an effect relating to the type of the item Y is produced. However, in a case where another character changes using an item X, the changed character is not newly set to selectable on the item selection screen for the player.

Next, the processor 21 performs a drawing process (step S16). In the drawing process, the processor 21 generates a game image based on the virtual camera relating to the player character and outputs the generated game image to the display 12 or an external display device.

Next, the processor 21 determines whether or not the set course ends (step S17). If all of the plurality of characters performing the first racing game reach the goal point, the determination of the processor 21 is YES in step S17. If, on the other hand, the set course does not end (step S17: NO), the processor 21 executes the process of step S11 again.

If the set course ends (step S17: YES), the processor 21 determines whether or not to continue the first racing game (step S18). For example, based on whether or not the entirety of the course set in the game setting process ends, the processor 21 may determine whether or not to continue the first racing game. Alternatively, the processor 21 may receive an operation input provided by the player, and based on the operation input, determine whether or not to continue the first racing game. If it is determined that the first racing game is to be continued (step S18: YES), the processor 21 performs a next course setting process (step S19). Here, a next course in the first racing game is set. In step S19, a character selection process may be performed based on an operation input provided by the player, and the player character may be changed. In step S19, the vehicle object may also be able to be changed based on an operation input provided by the player.

If the process of step S19 is performed, the processor 21 executes the process of step S10 again. Here, characters are placed on a course set in step S19.

If, on the other hand, it is determined that the first racing games is not to be continued (step S18: NO), the processor 21 determines whether or not to end the game (step S20). Here, the processor 21 determines whether or not an instruction to end the game is given by the player.

If it is determined that the game is not to be ended (step S20: NO), next, the processor 21 performs second game processing (step S7). In a case where the first racing game is not to be continued (i.e., in a case where the first racing game is to be ended), and if an instruction to end the game is not given, the second racing game is performed by the player character immediately after the first racing game. For example, the second racing game may be started from the end position of the first racing game.

If, on the other hand, it is determined that the game is to be ended (step S20: YES), the processor 21 ends the process shown in FIG. 21.

### (Second Game Processing)

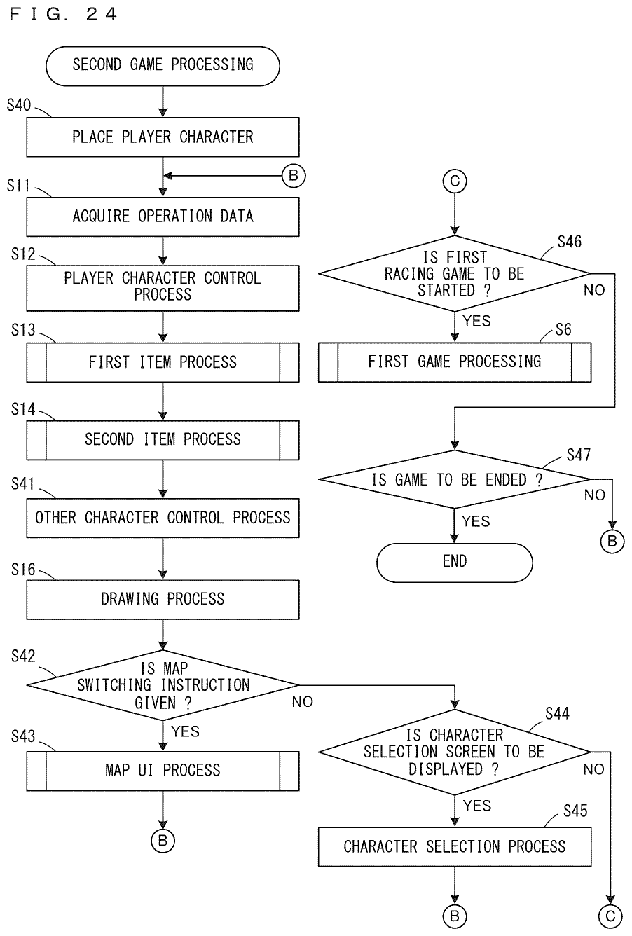

Next, the second game processing is described. FIG. 24 is a flow chart showing an example of the second game processing. For example, the second game processing is executed in a case where the second racing game is selected in the above game setting process and an instruction to start the game is given. After the first racing game ends, the second game processing is executed. In FIG. 24, processes similar to those in FIG. 21 are designated by the same numbers, and are not described.

In the second game processing, the processor 21 places the player character on the field and also sets a plurality of other characters (e.g., characters of the first type) at positions on the field (step S40). Specifically, the processor 21 places the player character at a position on the field. The processor 21 also sets a plurality of other characters at positions on the field. The positions of the other characters are dispersedly set so as not to be concentrated at a particular position on the field. For example, the positions of the other characters may be set in or near base areas on the field.

After step S40, the processor 21 executes the processes of steps S11 to S14.

After step S14, the processor 21 executes an other character control process (step S41). In the other character control process in step S41, the processor 21 updates the positions of the other characters set at the positions on the field based on a predetermined algorithm.

After step S41, the processor 21 executes a drawing process (step S16). If another character is included within the imaging range of the virtual camera relating to the player character, a game image including the player character and the other character is generated.

After step S16, based on the operation data, the processor 21 determines whether or not a map switching instruction is given by the player (step S42).

If it is determined that a map switching instruction is given by the player (step S42: YES), the processor 21 executes a map UI process (step S43). The details of the map UI process are described below.

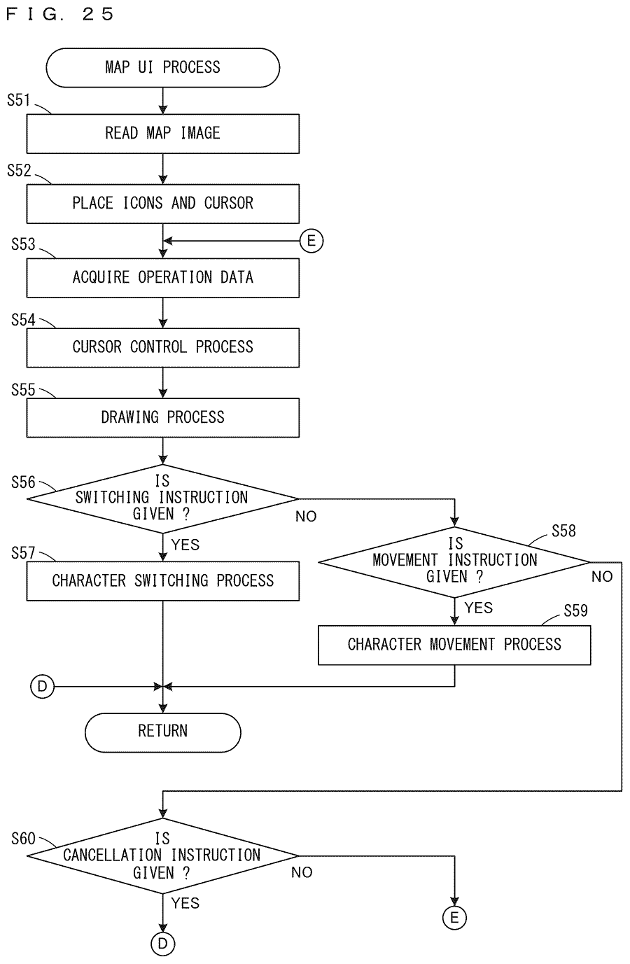

FIG. 25 is a flow chart showing an example of the map UI process in step S43.

As shown in FIG. 25, first, the processor 21 reads the map image (step S51).

Next, the processor 21 places icons relating to the characters on the map image in accordance with the positions of the characters (step S52). Specifically, the processor 21 places an icon of the player character at a position on the map image relating to the position on the field of the player character updated in step S12. The processor 21 also places icons of the other characters at positions on the map image relating to the positions on the field of the other characters updated in step S41. The processor 21 also places the cursor 81.

Next, the processor 21 acquires operation data (step S53).

Next, the processor 21 performs a cursor control process (step S54). Here, based on the operation data, the processor 21 controls the cursor 81.

Next, the processor 21 performs a drawing process (step S55). Specifically, the processor 21 generates an image obtained by superimposing the icon indicating the position of the player character, the icons indicating the positions of the other characters, and the cursor 81 on the map image. In a case where the position of the cursor 81 overlaps the icon of any of the characters, the processor 21 displays the information display 82 regarding the character. Next, based on the operation data, the processor 21 determines whether or not a switching instruction to switch the player character to another character is given (step S56). Specifically, the processor 21 determines whether or not a predetermined operation input is provided in a case where the position of the cursor 81 overlaps the position of the icon of another character.

If a switching instruction is given (step S56: YES), the processor 21 performs a character switching process (step S57). Specifically, the processor 21 changes the player character to another character specified using the cursor 81 and also sets the position of the player character to the position of the other character. For example, in a case where the player character before the switching instruction is given is the character 50a, and if the character 51 is specified using the cursor 81, the processor 21 changes the player character from the character 50a to the character 51a. The processor 21 also sets the position of the character 51 as the position of the player character. If the character 51 is specified using the cursor 81, the processor 21 may randomly set any of the plurality of characters 51a to 51d different in costume as the player character.

If, on the other hand, a switching instruction is not given (step S56: NO), the processor 21 determines whether or not a movement instruction to move the player character is given (step S58). Specifically, the processor 21 determines whether or not a predetermined operation input is provided in a case where the position of the cursor 81 is in a base area.

If a movement instruction is given (step S58: YES), the processor 21 performs a character movement process (step S59). Here, the processor 21 moves the player character to the base area specified using the cursor 81.

If, on the other hand, a movement instruction is not given (step S58: NO), based on the operation data, the processor 21 determines whether or not a cancellation instruction to end the map UI screen is given (step S60). If a cancellation instruction is not given (step S60: NO), the processor 21 executes the process of step S53 again. The processes of steps S53 to S55, S56, S58, and S60 are repeatedly executed at predetermined frame time intervals (e.g., 1/60-second intervals).

If the process of step S57 or S59 is performed, the processor 21 ends the process shown in FIG. 25, and the processing returns to FIG. 24. If the determination is YES in step S60, the processor 21 ends the process shown in FIG. 25, and the processing returns to FIG. 24. Consequently, the second racing game is resumed.

Referring back to FIG. 24, if the process of step S43 is performed, the processor 21 executes the process of step S11 again.

If, on the other hand, the determination is NO in step S42, based on the operation data, the processor 21 determines whether or not to display the character selection screen (step S44).

If it is determined that the character selection screen is to be displayed (step S44: YES), the processor 21 suspends the second racing game and performs a character selection process (step S45). While the character selection process is performed, the processor 21 repeatedly executes a process including a process of acquiring operation data and a drawing process at predetermined frame time intervals. Specifically, in the character selection process in step S45, the processor 21 displays the character selection screen exemplified in FIG. 3 and receives an operation input provided by the player. If an operation input for selecting a character is provided and an operation input for determining the selected character is provided, the processor 21 ends the character selection process in step S45. Consequently, while the position of the player character is maintained, the player character is changed to the character selected based on the operation input. If the character selection process is ended, the processor 21 executes the process of step S11 again. Consequently, the second racing game is resumed.

If the determination is NO in step S44, the processor 21 determines whether or not to start the first racing game (step S46). For example, if a condition for starting the first racing game is satisfied, the determination of the processor 21 is YES in step S46. The condition for starting the first racing game may be the fact that an instruction to start the first racing game is given by the player. The condition for starting the first racing game may be the fact that the player character enters a predetermined region on the field (e.g., enters an intra-base route). The condition for starting the first racing game may be the fact that a predetermined time elapses in a case where the first racing game transitions to the second racing game (in a case where step S7 is performed via the above step S20).

If it is determined that the first racing game is to be started (step S46: YES), the processor 21 executes the first game processing (step S6).

If, on the other hand, it is determined that the first racing game is not to be started (step S46: NO), the processor 21 determines whether or not to end the game (step S47). Here, the processor 21 determines whether or not an instruction to end the game is given by the player. If it is determined that the game is to be ended (step S47: YES), the processor 21 ends the process shown in FIG. 24.

If, on the other hand, it is determined that the game is not to be ended (step S47: NO), the processor 21 executes the process of step S11 again.

The processes of steps S11 to S16, S42, S44, S46, and S47 are repeatedly executed at predetermined frame time intervals (e.g., 1/60-second intervals), whereby the second racing game is advanced. If the player character uses an item X in the first classification during the second racing game, the player character is changed to a character of the same type and different in costume, or changed to a character of another type. The character to which the player character has changed using the item X in the first classification is set to selectable on the character selection screen. If a map switching instruction is given by the player during the second racing game, the map UI is displayed, and the player can switch the player character to another character or move the player character to another position using the map UI. If an instruction to display the character selection screen is given by the player during the second racing game, the character selection screen is displayed, and the player can change the player character on the character selection screen. If the condition for starting the first racing game is satisfied during the second racing game, the first racing game is started.

The processes shown in the above flow charts are merely illustrative, and the order and the contents of the processes, and the like may be appropriately changed.

As described above, in the exemplary embodiment, in a selection scene where the player is allowed to select a player character, the player is allowed to select any of selectable characters among playable characters of a plurality of types based on an operation input provided by the player (steps S2 and S45). In a running scene where the player character is caused to run (during the first racing game or the second racing game), based on the fact that the player character (e.g., 50a) hits the first item acquisition object 71 placed on the field, the player character is caused to acquire an item X in the first classification (step S22). Based on the acquisition of the item X, the player character is changed to a playable character of the first type (e.g., 50b or 50c) of the same type as the player character and different in external appearance from the player character or a playable character of the second type (e.g., 60) of a type different from the player character (step S25). Then, the character (e.g., 50b) to which the player character has changed is caused to run as the player character in the racing game. The character 50b to which the player character has changed is set to selectable on the item selection screen (step S27).

Consequently, the player can change the appearance of the player character while causing the player character to run in the racing game. The player can also increase selectable playable objects while causing the player character to run in the racing game.

If the player character is changed to a playable character of the second type, after the lapse of a predetermined time, the player character is changed back to the player character before the change (step S12 or S25). If the player character changes to a character of a different type, the player character is temporarily changed and then changed back to the original player character, whereby the player can experience a temporary change in the player character. Even if a character of a type selected by the player changes to a character of a type different from the character of the type selected by the player, the character changes back to the original character after the lapse of a predetermined time. Thus, it is possible to prevent the game from continuing using a character of a type different from a character selected by the player. If a character of a type selected by the player changes to a character of the same type as the character of the type selected by the player and different only in external appearance from the character of the type selected by the player, the player can continue the game using the character of the type selected by the player themselves and different in external appearance and enjoy a change in the external appearance.

In the exemplary embodiment, if the player character acquires an item X in the first classification, the player character enters the state where the first effect relating to the item X is implementable (the state where the first effect can be used). In the state where the first effect is implementable, in accordance with an implement instruction based on an operation input, the change of the player character to a playable character of the first type or the second type relating to the first effect (step S25) and the effect regarding running relating to the first effect (step S26) are produced.

It is possible to change the player character to a playable character of the first type or the second type while producing the effect regarding running, and the character after the change is set to selectable, whereby the player can increase selectable playable characters while using an item X in the first classification as a part of the game.

In the exemplary embodiment, in a case where the player character acquires an item Y in the second classification, the player character enters the state where the second effect relating to the item Y is implementable (the state where the second effect can be used). In the state where the second effect is implementable, in accordance with an implement instruction based on an operation input, the second effect is produced (step S34). The second effect differs in accordance with the type of the item Y, is any of a plurality of effects including the effect of accelerating the player character in response to the type of the item Y, and is an effect without the change of the player character.

An item X in the first classification involving the change of the player character produces the same effect as an item having an acceleration effect among a plurality of items Y in the second classification without the change of the player character. Thus, the player can acquire an item X in the first classification instead of an item Y in the second classification, change the player character, and increase selectable characters in the selection scene.

In the exemplary embodiment, the racing game where in a predetermined scene (the first racing game) included in the running scene (the first racing game or the second racing game), a movement range along a predetermined path is set on the field (step S5), and a plurality of characters including the player character are moved in the movement range is performed. In a scene where the racing game is performed by the plurality of characters, it is possible to change the player character based on the acquisition of an item X in the first classification and also increase selectable characters in the selection scene.

In the exemplary embodiment, in another scene (the second racing game) included in the running scene (the first racing game or the second racing game), the player character is caused to run on the field based on an operation input without setting a movement range (a course). Both in a scene where a movement range is set and a scene where a movement range is not set and the player character can freely run, it is possible to change the player character based on the acquisition of an item X in the first classification and also increase selectable characters in the selection scene.

In the exemplary embodiment, in the running scene, the player character is caused to run on the field based on an operation input. A plurality of other playable characters are set at different positions on the field (step S40). If any of the plurality of other playable characters set at other positions on the field is specified based on an operation input, the running scene is resumed from the position of the specified playable character, and the specified playable character is changed to the player character (step S57). Then, the player character after the change is caused to run on the field based on an operation input.

Consequently, the player can cause various characters to run by operating the various characters at various locations on the field.

In the exemplary embodiment, the map UI including a map image, a first indicator indicating the position on the field of the player character (the icon 90 of the player character), and a second indicator indicating the position on the field of another playable character (the icon 91 or 92 of another character) is displayed in accordance with an operation input provided by the player. Consequently, the player can specify a playable character to which the player character is to be changed, while confirming a position on the field.

In the exemplary embodiment, in the map UI, the second indicator includes information indicating characters set to selectable on the character selection screen (the information display 82). Consequently, the player can acquire and use an item X in the first classification, or switch the player character to a character of the first type at another location while confirming characters set to selectable. Thus, it is possible to allow the player to use various items X at various locations.

In the exemplary embodiment, a plurality of base areas (locations) on the field are displayed in the map UI, and if any of the base areas is specified by the player, the racing game is resumed by moving the player character to the specified base area. Consequently, it is also possible to change the position of the player character without changing the player character.

### VARIATIONS

While the exemplary embodiment has been described above, the exemplary embodiment is merely an example and may be modified as follows, for example.

For example, in the above exemplary embodiment, in a case where the player character 50a uses an item X in the first classification, the player character 50a is changed to the character 50b of the same type and different in costume. For example, the character 50b may be a character that is a model that is the same as the character 50a and different only in color or texture.

In the above exemplary embodiment, a plurality of characters different in costume are displayed on the character selection screen, and the player is allowed to select any of the plurality of characters different in costume. In another exemplary embodiment, the player may be allowed to select the character type (e.g., the character 50) and further allowed to select any of a plurality of costumes on the character selection screen. In this case, 3D model data indicating a character of a single type and 3D model data indicating a plurality of costumes may be stored in advance, and based on the selection of a character and a costume by the player, a plurality of characters of the same type and different in external appearance may be generated using data of the selected character and costume.

In the above exemplary embodiment, a racing game where a character runs on a vehicle object is performed. In another exemplary embodiment, a racing game where only a character runs may be performed, or a racing game where only a vehicle object runs may be performed. A racing game may be performed using any player objects including a character and a vehicle object. In this case, as described above, based on the acquisition of an item X in the first classification, a player object is changed to a playable object of the first type of the same type and different in external appearance or to a playable object of the second type of a different type. A playable object may be a playable character that can be operated by the player, or may be a vehicle object that can be operated by the player. During the racing game, a player object is changed to another playable object using a map UI, and the racing game is resumed from the position of the other playable object.

In the above exemplary embodiment, if the player character changes to a playable character of the first type based on an item X in the first classification, after the lapse of a predetermined time, the player character is not changed back to the original player character. If the player character changes to a playable character of the second type, after the lapse of the predetermined time, the player character is changed back to the original player character. In another exemplary embodiment, also if the player character changes to a playable character of the first type different in costume, after the lapse of the predetermined time, the player character may be changed back to the original player character.

In the above exemplary embodiment, only selectable characters among a plurality of playable characters are displayed on the character selection screen. In another exemplary embodiment, all the playable characters also including characters unselectable at the current moment may be displayed on the character selection screen. In this case, the selectable characters and the unselectable characters may be displayed in different display forms on the character selection screen. For example, the unselectable characters may be grayed out and controlled so that the unselectable characters cannot be selected by the player.

In the above exemplary embodiment, if the player character comes into contact with the first item acquisition object, a single item X in the first classification is given to the player character. In another exemplary embodiment, if the player character comes into contact with a first item acquisition object, a plurality of items X in the first classification may be given to the player character. For example, a first item acquisition object with which a plurality of items X in the first classification are given to the player character and a first item acquisition object with which a single item X in the first classification is given to the player character may be placed on the field. If the player character comes into contact with a first item acquisition object, the number of items X in the first classification to be given to the player character may be randomly determined.

In the above exemplary embodiment, the map UI is displayed during the second racing game, and if another character is specified in the map UI, the player character is changed to the specified other character, and the second racing game is resumed from the position of the other character. Here, “the second racing game is resumed from the position of the other character” includes both the resumption of the second racing game from the exact position of the other character at the current moment and the resumption of the second racing game from a predetermined position in a range relating to the position of the other character at the current moment. For example, if a particular position on the intra-base route CA1 is set as the exact position of the other character at the current moment, the second racing game may be resumed from the particular position, or may be resumed not from the particular position but from a position (e.g., the starting point) set in advance on the intra-base route CA1.

In the above exemplary embodiment, using the map UI, the player is allowed to select another character to which the player character is to be switched. In another exemplary embodiment, using not only the map UI but also another user interface, the player may be allowed to select another character to which the player character is to be switched.

The above processing may be executed not only by the game system 1, but also by any other information processing apparatus or information processing system. The information processing system may include a plurality of apparatuses, and the plurality of apparatuses may be connected to each other via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of an information processing apparatus to execute game processing comprising:
in a first scene where a player is allowed to select a player object,
allowing the player to select the player object to be used by the player from selectable playable objects among playable objects of a plurality of types based on an operation input; and
in a second scene where the player object is caused to run,
causing the player object to run on a field based on an operation input, and
based on acquisition of an item in a first classification on the field by the player object, changing the player object to a playable object of a first type of the same type as and different in external appearance from the player object or to a playable object of a second type of a type different from the player object, causing the playable object to run as the player object, and if the playable object as the change destination is not selectable in the first scene, setting the playable object to selectable.

2. The one or more non-transitory computer-readable media according to claim 1, wherein
the game processing further comprises
in the second scene,
if the player object is changed to, between a playable object of the first type and a playable object of the second type, the playable object of the second type based on acquisition of an item in the first classification, after a lapse of a predetermined period, changing the playable object again to the player object before the change.

3. The one or more non-transitory computer-readable media according to claim 2, wherein
the playable objects are characters,
a playable object of the first type is set with respect to each character of the player object and the same character as the character and is any of a plurality of characters different in costume, and
a playable object of the second type is an object of a character different from the character of the player object.

4. The one or more non-transitory computer-readable media according to claim 3, wherein
a playable object of the second type is a character for which the same character different in costume is not set.

5. The one or more non-transitory computer-readable media according to claim 3, wherein
the game processing further comprises:
in the first scene,
allowing the player to select a vehicle object that the character is to be on based on an operation input; and
in the second scene,
causing the character to run in a state where the character is on the selected vehicle object.

6. The one or more non-transitory computer-readable media according to claim 1, wherein
the game processing further comprises:
in the second scene,
in accordance with acquisition of an item in the first classification, bringing the player object into a state where a first effect relating to the item in the first classification is implementable; and
in a state where the first effect is implementable, in accordance with an instruction to use the item in the first classification based on an operation input, changing the player object to a playable object relating to the first effect between the playable object of the first type and the playable object of the second type and producing an effect regarding running relating to the first effect.

7. The one or more non-transitory computer-readable media according to claim 6, wherein
the effect regarding the running relating to the first effect is an effect of accelerating the player object,
the game processing further comprises:
in the second scene,
in accordance with acquisition of an item in a second classification on the field by the player object, bringing the player object into a state where a second effect that is any of a plurality of effects relating to a type of the item in the second classification and including an effect of accelerating the playable object is implementable and that does not involve a change of the player object; and
in the state where the second effect is implementable, in accordance with an instruction to use the item in the second classification based on an operation input, producing the second effect.

8. The one or more non-transitory computer-readable media according to claim 1, wherein
the game processing further comprises,
in a third scene included in the second scene,
setting a movement range along a predetermined path on the field,
moving a plurality of objects including the player object within the movement range, and causing the plurality of objects to race each other.

9. The one or more non-transitory computer-readable media according to claim 8, wherein
the game processing further comprises
in a fourth scene included in the second scene,
causing the player object to run on the field based on an operation input without setting the movement range along the path on the field.

10. The one or more non-transitory computer-readable media according to claim 1, wherein
at least any of a change of the player object to which of playable objects of the first type and a change of the player object to which of playable objects of the second type is set in association with respect to each of types of items in the first classification with respect to each player object,
the game processing further comprises
in the second scene,
based on acquisition of an item in the first classification, changing the player object to a playable object of the first type or a playable object of the second type relating to the type of the acquired item in the first classification.

11. The one or more non-transitory computer-readable media according to claim 1, wherein
the game processing further comprises
in the second scene,
based on contact between the player object and any of item acquisition objects which are placed at a plurality of locations on the field such that at least one of types of items in the first classification is set with respect to each location, causing the player object to acquire an item in the first classification of the type set for the item acquisition object.

12. An information processing system comprising: one or more processors that execute game processing comprising:
in a first scene where a player is allowed to select a player object,
allowing the player to select the player object to be used by the player from selectable playable objects among playable objects of a plurality of types based on an operation input; and
in a second scene where the player object is caused to run,
causing the player object to run on a field based on an operation input, and
based on acquisition of an item in a first classification on the field by the player object, changing the player object to a playable object of a first type of the same type as and different in external appearance from the player object or to a playable object of a second type of a type different from the player object, causing the playable object to run as the player object, and if the playable object as the change destination is not selectable in the first scene, setting the playable object to selectable.

13. The information processing system according to claim 12, wherein
the game processing further comprises
in the second scene,
if the player object is changed to, between a playable object of the first type and a playable object of the second type, the playable object of the second type based on acquisition of an item in the first classification, after a lapse of a predetermined period, changing the playable object again to the player object before the change.

14. The information processing system according to claim 13, wherein
the playable objects are characters,
a playable object of the first type is set with respect to each character of the player object and the same character as the character and is any of a plurality of characters different in costume, and
a playable object of the second type is an object of a character different from the character of the player object.

15. The information processing system according to claim 14, wherein
a playable object of the second type is a character for which the same character different in costume is not set.

16. The information processing system according to claim 14, wherein
the game processing further comprises:
in the first scene,
allowing the player to select a vehicle object that the character is to be on based on an operation input; and
in the second scene,
causing the character to run in a state where the character is on the selected vehicle object.

17. The information processing system according to claim 12, wherein
the game processing further comprises:
in the second scene,
in accordance with acquisition of an item in the first classification, bringing the player object into a state where a first effect relating to the item in the first classification is implementable; and
in a state where the first effect is implementable, in accordance with an instruction to use the item in the first classification based on an operation input, changing the player object to a playable object relating to the first effect between the playable object of the first type and the playable object of the second type and producing an effect regarding running relating to the first effect.

18. The information processing system according to claim 17, wherein
the effect regarding the running relating to the first effect is an effect of accelerating the player object,
the game processing further comprises:
in the second scene,
in accordance with acquisition of an item in a second classification on the field by the player object, bringing the player object into a state where a second effect that is any of a plurality of effects relating to a type of the item in the second classification and including an effect of accelerating the playable object is implementable and that does not involve a change of the player object; and
in the state where the second effect is implementable, in accordance with an instruction to use the item in the second classification based on an operation input, producing the second effect.

19. The information processing system according to claim 12, wherein
the game processing further comprises,
in a third scene included in the second scene,
setting a movement range along a predetermined path on the field,
moving a plurality of objects including the player object within the movement range, and causing the plurality of objects to race each other.

20. The information processing system according to claim 19, wherein
the game processing further comprises
in a fourth scene included in the second scene,
causing the player object to run on the field based on an operation input without setting the movement range along the path on the field.

21. The information processing system according to claim 12, wherein
at least any of a change of the player object to which of playable objects of the first type and a change of the player object to which of playable objects of the second type is set in association with respect to each of types of items in the first classification with respect to each player object,
the game processing further comprises
in the second scene,
based on acquisition of an item in the first classification, changing the player object to a playable object of the first type or a playable object of the second type relating to the type of the acquired item in the first classification.

22. The information processing system according to claim 12, wherein
the game processing further comprises
in the second scene,
based on contact between the player object and any of item acquisition objects which are placed at a plurality of locations on the field such that at least one of types of items in the first classification is set with respect to each location, causing the player object to acquire an item in the first classification of the type set for the item acquisition object.

23. An information processing method performed by an information processing system, the information processing method comprising:
in a first scene where a player is allowed to select a player object,
allowing the player to select the player object to be used by the player from selectable playable objects among playable objects of a plurality of types based on an operation input; and
in a second scene where the player object is caused to run,
causing the player object to run on a field based on an operation input, and
based on acquisition of an item in a first classification on the field by the player object, changing the player object to a playable object of a first type of the same type as and different in external appearance from the player object or to a playable object of a second type of a type different from the player object, causing the playable object to run as the player object, and if the playable object as the change destination is not selectable in the first scene, setting the playable object to selectable.

24. The information processing method according to claim 23, further comprising
in the second scene,
if the player object is changed to, between a playable object of the first type and a playable object of the second type, the playable object of the second type based on acquisition of an item in the first classification, after a lapse of a predetermined period, changing the playable object again to the player object before the change.

25. The information processing method according to claim 24, wherein
the playable objects are characters,
a playable object of the first type is set with respect to each character of the player object and the same character as the character and is any of a plurality of characters different in costume, and
a playable object of the second type is an object of a character different from the character of the player object.

26. The information processing method according to claim 25, wherein
a playable object of the second type is a character for which the same character different in costume is not set.

27. The information processing method according to claim 25, further comprising:
in the first scene,
allowing the player to select a vehicle object that the character is to be on based on an operation input; and
in the second scene,
causing the character to run in a state where the character is on the selected vehicle object.

28. The information processing method according to claim 23, further comprising:
in the second scene,
in accordance with acquisition of an item in the first classification, bringing the player object into a state where a first effect relating to the item in the first classification is implementable; and
in a state where the first effect is implementable, in accordance with an instruction to use the item in the first classification based on an operation input, changing the player object to a playable object relating to the first effect between the playable object of the first type and the playable object of the second type and producing an effect regarding running relating to the first effect.

29. The information processing method according to claim 28, wherein
the effect regarding the running relating to the first effect is an effect of accelerating the player object,
the information processing method further comprises:
in the second scene,
in accordance with acquisition of an item in a second classification on the field by the player object, bringing the player object into a state where a second effect that is any of a plurality of effects relating to a type of the item in the second classification and including an effect of accelerating the playable object is implementable and that does not involve a change of the player object; and
in the state where the second effect is implementable, in accordance with an instruction to use the item in the second classification based on an operation input, producing the second effect.

30. The information processing method according to claim 23, further comprising
in a third scene included in the second scene,
setting a movement range along a predetermined path on the field, moving a plurality of objects including the player object within the movement range, and causing the plurality of objects to race each other.

31. The information processing method according to claim 30, further comprising
in a fourth scene included in the second scene,
causing the player object to run on the field based on an operation input without setting the movement range along the path on the field.

32. The information processing method according to claim 23, wherein
at least any of a change of the player object to which of playable objects of the first type and a change of the player object to which of playable objects of the second type is set in association with respect to each of types of items in the first classification with respect to each player object,
the information processing method further comprises
in the second scene,
based on acquisition of an item in the first classification, changing the player object to a playable object of the first type or a playable object of the second type relating to the type of the acquired item in the first classification.

33. The information processing method according to claim 23, further comprising
in the second scene,
based on contact between the player object and any of item acquisition objects which are placed at a plurality of locations on the field such that at least one of types of items in the first classification is set with respect to each location, causing the player object to acquire an item in the first classification of the type set for the item acquisition object.

34. An information processing apparatus comprising: one or more processors that execute game processing comprising:
in a first scene where a player is allowed to select a player object,
allowing the player to select the player object to be used by the player from selectable playable objects among playable objects of a plurality of types based on an operation input; and
in a second scene where the player object is caused to run,
causing the player object to run on a field based on an operation input, and
based on acquisition of an item in a first classification on the field by the player object, changing the player object to a playable object of a first type of the same type as and different in external appearance from the player object or to a playable object of a second type of a type different from the player object, causing the playable object to run as the player object, and if the playable object as the change destination is not selectable in the first scene, setting the playable object to selectable.
